(19) United States
(12) Patent Application Publication
(10) Pub. No.: US 2026/0073686 A1
(43) Pub. Date: Mar. 12, 2026

(54) WEARABLE DEVICE, METHOD, AND NON-TRANSITORY COMPUTER READABLE STORAGE MEDIUM FOR DISPLAYING OBJECT IN VIRTUAL ENVIRONMENT

(71) Applicant: Samsung Electronics Co., Ltd., Suwon-si (KR)

(72) Inventors: Hyuntaek WOO, Suwon-si (KR); Sungoh KIM, Suwon-si (KR); Donghyun YEOM, Suwon-si (KR); Jooyoung KIM, Suwon-si (KR); Myeongseop SONG, Suwon-si (KR); Sanghun LEE, Suwon-si (KR)

(21) Appl. No.: 19/288,233

(22) Filed: Aug. 1, 2025

Related U.S. Application Data
(63) Continuation of application No. PCT/KR2025/010224, filed on Jul. 11, 2025.

(30) Foreign Application Priority Data
Sep. 11, 2024 (KR) 10-2024-0124318
Oct. 22, 2024 (KR) 10-2024-0145106

(51) Int. Cl. G06V 20/20; G06F 3/01; G06T 11/00; G06V 40/20

(52) U.S. Cl. CPC G06V 20/20; G06F 3/011; G06F 3/017; G06T 11/00; G06V 40/28

(57) ABSTRACT

A wearable device is provided. The wearable device includes at least one processor, a display, and at least one camera. The at least one processor is configured to identify an object included in a virtual screen displayed through the display using the at least one camera, determine whether the identified object corresponds to a type for restricting a representation of a hand object of a user, display, through the display, a virtual screen including the hand object based on a hand tracking in accordance with a determination that the identified object does not correspond to the type, and display, through the display, a virtual screen without displaying a movement of the hand object in accordance with the hand tracking based on identifying that the hand object is located within a threshold distance from the identified object in accordance with a determination that the identified object corresponds to the type.

### CROSS-REFERENCE TO RELATED APPLICATION(S)

This application is a continuation application, claiming priority under 35 U.S.C. § 365 (c), of an International application No. PCT/KR2025/010224, filed on Jul. 11, 2025, which is based on and claims the benefit of a Korean patent application number 10-2024-0124318, filed on Sep. 11, 2024, in the Korean Intellectual Property Office, and of a Korean patent application number 10-2024-0145106, filed on Oct. 22, 2024, in the Korean Intellectual Property Office, the disclosure of each of which is incorporated by reference herein in its entirety.

### BACKGROUND

### 1. Field

The disclosure relates to a wearable device, a method, and a non-transitory computer-readable storage medium for displaying an object in a virtual environment.

### 2. Description of Related Art

A wearable device providing extended reality may perform hand tracking of a user and object tracking.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable device, a method, and a non-transitory computer readable storage medium for displaying an object in a virtual environment.

Additional aspects will be set forth in part in the description which follows and, in part, will be apparent from the description, or may be learned by practice of the presented embodiments.

In accordance with an aspect of the disclosure, a wearable device is provided. The wearable device includes at least one camera, a display, memory, including one or more storage media, storing instructions, at least one processor including processing circuitry and communicatively coupled to the at least one camera, the display, and the memory, wherein the instructions, when executed by the at least one processor individually or collectively, cause the wearable device to identify an object included in a virtual screen displayed through the display using the at least one camera, determine whether the identified object corresponds to a type for restricting a representation of a hand object of a user, display, through the display, a virtual screen including the hand object based on a hand tracking in accordance with a determination that the identified object does not correspond to the type, and display, through the display, a virtual screen without displaying a movement of the hand object in accordance with the hand tracking based on identifying that the hand object is located within a threshold distance from the identified object in accordance with a determination that the identified object corresponds to the type.

In accordance with another aspect of the disclosure, a method performed by a wearable device including a display and at least one camera is provided. The method identifying an object included in a virtual screen displayed through the display using the at least one camera, determining whether the identified object corresponds to a type for restricting a representation of a hand object of a user, displaying, through the display, a virtual screen including the hand object based on a hand tracking in accordance with a determination that the identified object does not correspond to the type, and displaying, through the display, a virtual screen without displaying a movement of the hand object in accordance with the hand tracking based on identifying that the hand object is located within a threshold distance from the identified object in accordance with a determination that the identified object corresponds to the type.

In accordance with another aspect of the disclosure, one or more non-transitory computer-readable storage media storing one or more programs, including computer-executable instructions that, when executed by at least one processor of a wearable device including a display and at least one camera individually or collectively, cause the wearable device to perform operations are provided. The operations include identifying an object included in a virtual screen displayed through the display using the at least one camera, determining whether the identified object corresponds to a type for restricting a representation of a hand object of a user, displaying, through the display, a virtual screen including the hand object based on a hand tracking in accordance with a determination that the identified object does not correspond to the type, and displaying, through the display, a virtual screen without displaying a movement of the hand object in accordance with the hand tracking based on identifying that the hand object is located within a threshold distance from the identified object in accordance with a determination that the identified object corresponds to the type.

In accordance with another aspect of the disclosure, a wearable device is provided. The wearable device includes at least one display, at least one sensor, memory, including one or more storage media, storing instructions, and at least one processor including processing circuitry and communicatively coupled to the at least one display, the at least one sensor, and the memory, wherein the instructions, when executed by the at least one processor individually or collectively, cause the wearable device to obtain object information data on an object identified by the at least one sensor, obtain tracking data by tracking a body part identified by the at least one sensor, identify whether a designated condition is fulfilled, based on the identification, determine a subject or a scope of a tracking, or determine a subject or a scope of the tracking data processed by the at least one processor.

In accordance with another aspect of the disclosure, a method is provided. The method includes obtaining object information data on an object identified by the at least one sensor, obtaining tracking data by tracking a body part identified by the at least one sensor, identifying whether a designated condition is fulfilled, based on the identification, determining a subject or a scope of a tracking, or determining a subject or a scope of the tracking data processed by the at least one processor.

In accordance with another aspect of the disclosure, one or more non-transitory computer-readable storage media storing one or more programs including instructions that, when executed by at least one processor of a wearable device individually or collectively, cause the wearable device to perform operations are provided. The operations include obtaining object information data on an object identified by the at least one sensor, obtaining tracking data by tracking a body part identified by the at least one sensor, identifying whether a designated condition is fulfilled, based on the identification, determining a subject or a scope of a tracking, or determining a subject or a scope of the tracking data processed by the at least one processor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates a perspective view of a wearable device according to an embodiment of the disclosure;

FIG. 2B illustrates one or more hardware disposed in a wearable device according to an embodiment of the disclosure;

FIGS. 3A and 3B illustrate an exterior surface of a wearable device according to various embodiments of the disclosure;

FIG. 4 illustrates a block diagram of a wearable device according to an embodiment of the disclosure;

FIG. 5 illustrates a block diagram of a wearable device for displaying an image in a virtual space according to an embodiment of the disclosure;

FIG. 6 is a block diagram illustrating an operation of a wearable device performing object tracking and hand tracking according to an embodiment of the disclosure;

FIG. 7 is a flowchart illustrating an operation of a wearable device for restricting a display of a user's hand object in a virtual screen according to an embodiment of the disclosure;

FIGS. 8A, 8B, and 8C illustrate an operation of a wearable device for restricting a display of a user's hand object in a virtual screen according to various embodiments of the disclosure;

FIG. 9 is a flowchart illustrating an operation of a wearable device for restricting an interaction of a user's hand object in a virtual screen according to an embodiment of the disclosure;

FIG. 10 illustrates a restriction of an interaction by a user's hand in a virtual screen according to an embodiment of the disclosure;

FIG. 11 is a flowchart illustrating an operation of a wearable device for processing a hand object in a virtual screen in accordance with a type of an object in a virtual screen according to an embodiment of the disclosure; and

FIG. 12 is a flowchart illustrating an operation of a wearable device for processing a hand object in a virtual screen in accordance with a type of an object in a virtual screen according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used in the disclosure are used only to describe a specific embodiment of the disclosure, and may not be intended to limit a range of various embodiments. A singular expression may include a plural expression unless the context clearly means otherwise. Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

Terms referring to an image (e.g., image, frame, camera frame, photographed image, camera image), terms referring to a user's hand (e.g., hand object, candidate object, hand candidate object, boundary box, candidate hand object), terms referring to a signal (e.g., signaling, control signal, data, control data, request signal, information), terms referring to a location (e.g., location information, area information, object information, object location, object coordinate, reference object, coordinate information, location, coordinate, relative coordinate, absolute coordinate, coordinate system), the terms referring to a value (e.g., threshold value, reference value, reference area, reference range, level, threshold level, threshold, range, value, area), terms for an operation state (e.g., step, operation, procedure), or terms referring to a component of a device, used in the following description, are exemplified for convenience of explanation. Therefore, the disclosure is not limited to terms to be described below, and another term having an equivalent technical meaning may be used. In addition, a term, such as ‘ . . . unit,’ . . . device, ‘ . . . object’, and ‘ . . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

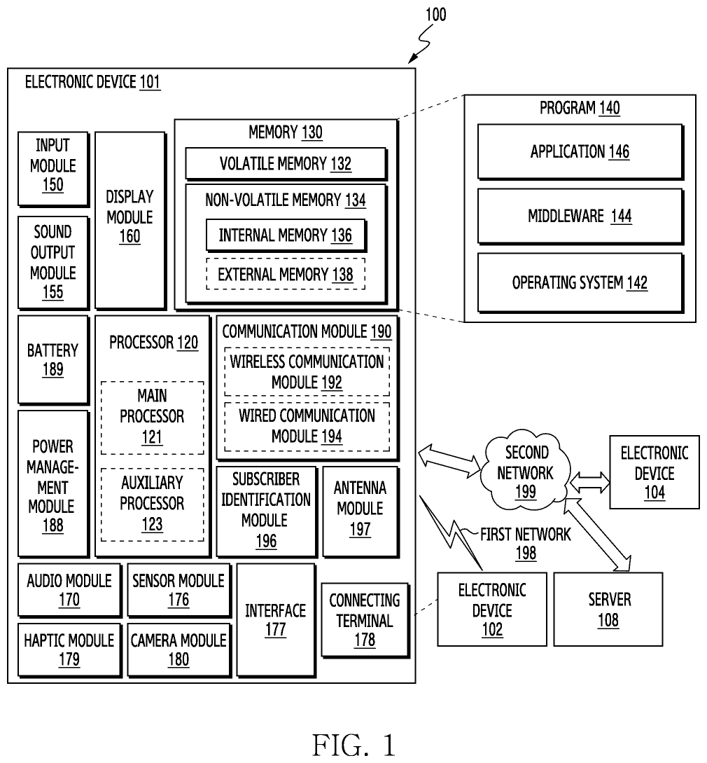

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and/or external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

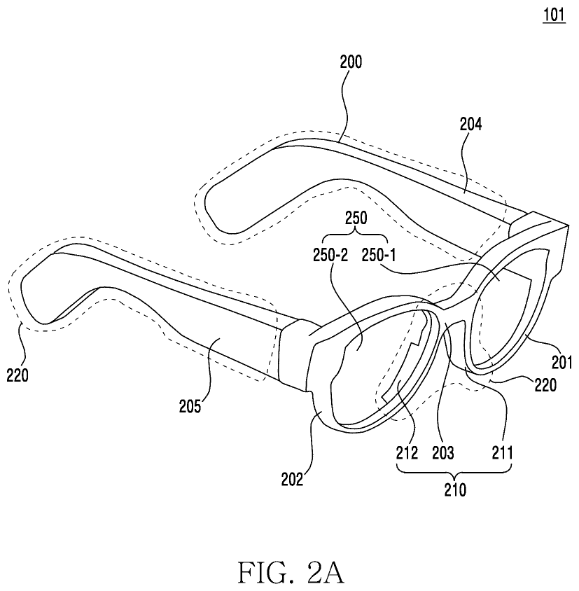

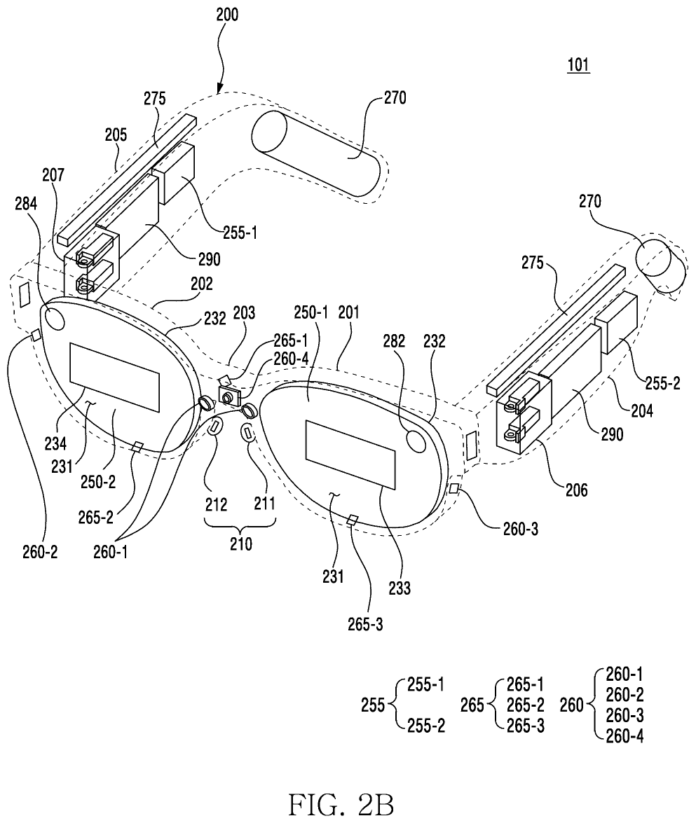

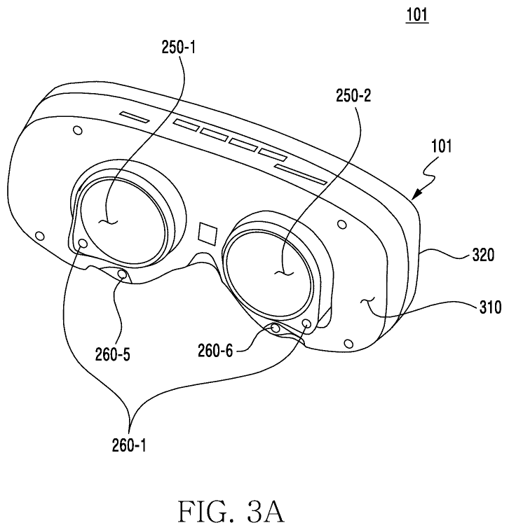

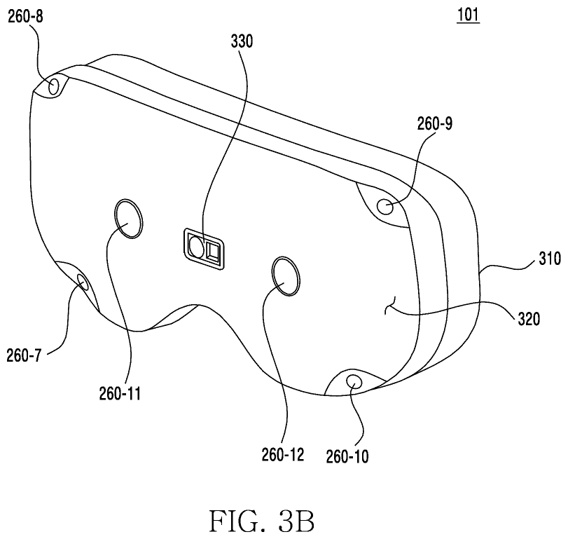

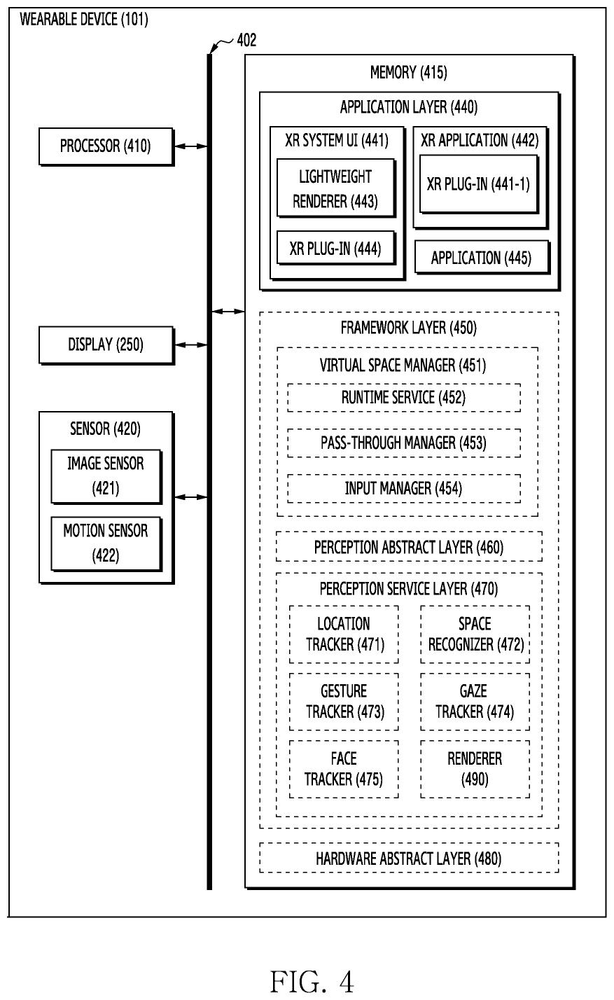

In embodiments of the disclosure, an electronic device (e.g., the electronic device 101 of FIG. 1) for displaying an image in a virtual space may be a wearable device. The wearable device 101 may include a head-mounted display (HMD) that is wearable on the user's head. The wearable device 101 may be referred to as a head-mount device (HMD), a headgear electronic device, a glasses-type electronic device, a video see-through (or visible see-through) (VST) device, an extended reality (XR) device, a virtual reality (VR) device, and/or an augmented reality (AR) device. Although the appearance of the wearable device 101 in the form of glasses is illustrated, an embodiment of the disclosure is not limited thereto. An example of a hardware configuration included in the wearable device 101 will be described with reference to FIG. 4. An example of a structure of the wearable device 101 that is wearable on the user's head will be described with reference to FIGS. 2A, 2B, 3A, and/or 3B. The wearable device 101 may be referred to as an electronic device. For example, the electronic device may be combined with an accessory (e.g., a strap) for being attached to the user's head to form an HMD.

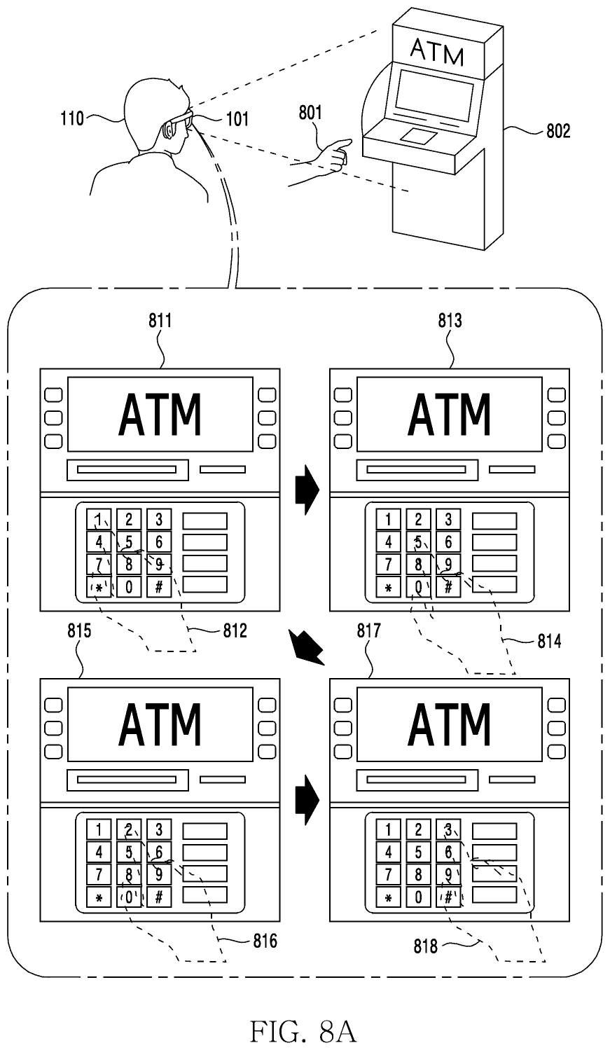

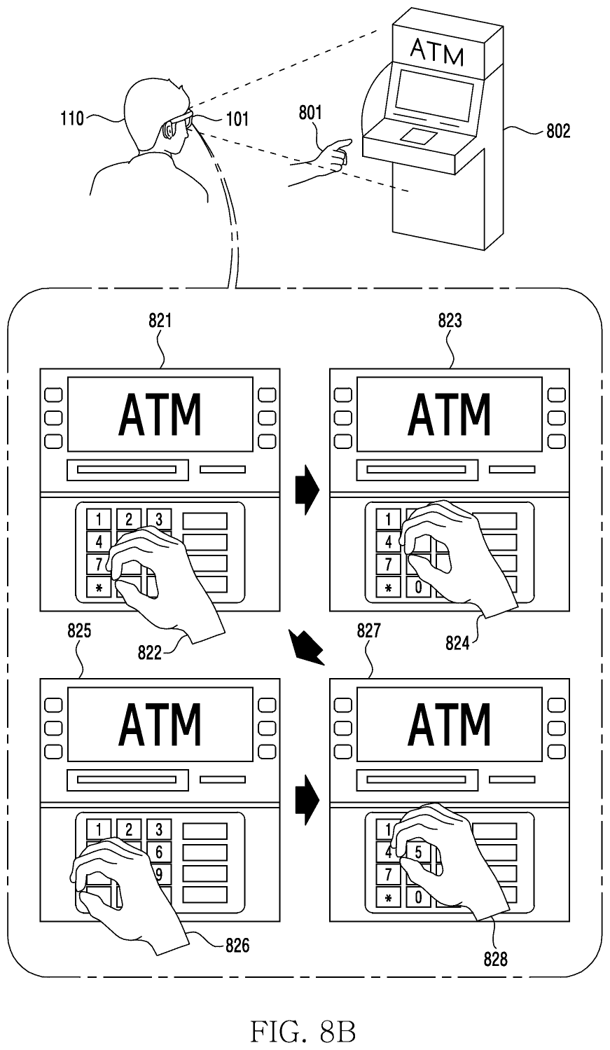

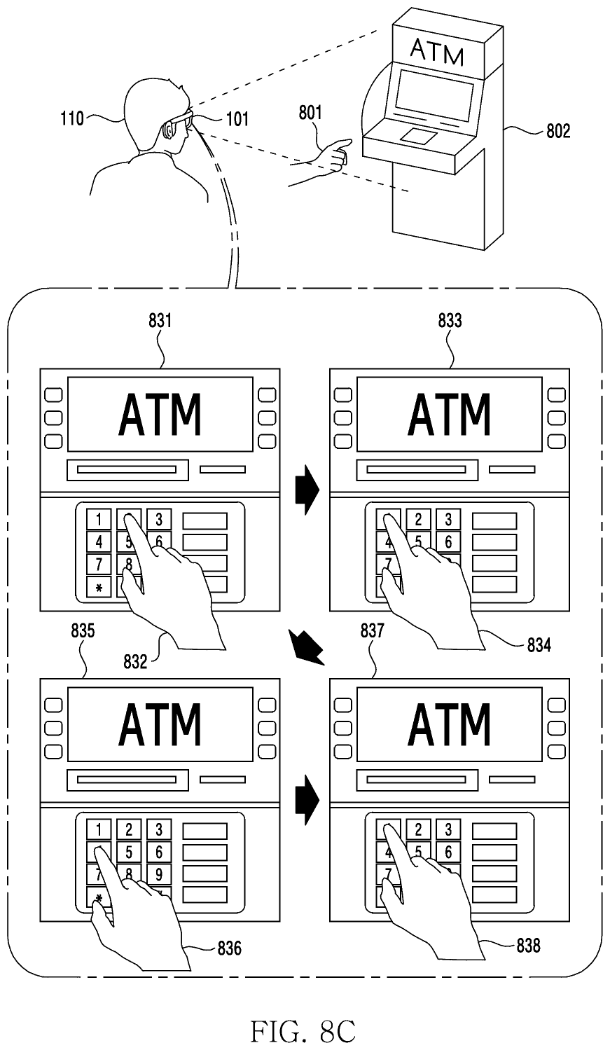

In an embodiment of the disclosure, the wearable device 101 may execute a function related to augmented reality (AR) and/or mixed reality (MR). For example, in a state that a user (e.g., the user 110 of FIG. 8A) wears the wearable device 101, the wearable device 101 may include at least one lens disposed adjacent to the user 110's eyes. The wearable device 101 may combine ambient light passing through the lens with light emitted from a display of the wearable device 101. A display area of the display may be formed within a lens through which ambient light passes. Since the wearable device 101 combines the ambient light and the light emitted from the display, the user 110 may see an image in which a real object (or a physical object) recognized by the ambient light and a virtual object formed by the light emitted from the display are mixed. The above-described AR, MR, and/or VR may be referred to as extended reality (XR).

In an embodiment of the disclosure, the wearable device 101 may execute a function related to a video see-through (or visual see-through) (VST) and/or virtual reality (VR). For example, in a state that the user 110 wears the wearable device 101, the wearable device 101 may include a housing covering eyes of the user 110. The wearable device 101 may include a display disposed on a first surface of the housing facing the eye, in the state. The wearable device 101 may include a camera disposed on a second surface opposite to the first surface. Using the camera, the wearable device 101 may obtain an image and/or video representing ambient light. The wearable device 101 may output the image and/or video in the display disposed on the first surface so that the user 110 recognizes the ambient light through the display. A displaying area (or an active area) of the display disposed on the first surface may be formed by one or more pixels included in the display. The wearable device 101 may synthesize a virtual object with the image and/or video outputted through the display to enable the user 110 to recognize the virtual object together with a real object recognized by the ambient light.

In an embodiment of the disclosure, the wearable device 101 may identify or recognize a location (or position) or a direction (or orientation) of the wearable device 101, based on the image and/or video obtained using the camera. The wearable device 101 may obtain information on an external space by using one or more cameras and/or one or more sensors. The information may include a geographic location (e.g., global positioning system (GPS) coordinate) of an external space identified from one or more sensors. The information may include an image and/or video of an external space identified from one or more cameras. The wearable device 101 may identify external objects included in the external space from the image and/or video, by performing object recognition on the image and/or video.

Hereinafter, an example of a hardware configuration of the wearable device 101 will be described with reference to FIGS. 2A, 2B, 3A, 3B, and 4.

FIG. 2A illustrates a perspective view of a wearable device according to an embodiment of the disclosure.

FIG. 2B illustrates one or more hardware disposed in the wearable device according to an embodiment of the disclosure.

A wearable device 101 according to an embodiment may have a shape of glasses that are wearable on a body part (e.g., a head) of the user 110. The wearable device 101 of FIGS. 2A and 2B may be an example of the electronic device 101 of FIG. 1. The wearable device 101 may include a head-mounted display (HMD). For example, a housing of the wearable device 101 may include a flexible material, such as rubber and/or silicone, having a shape that is in close contact with a portion (e.g., a portion of a face surrounding both eyes) of the head of the user 110. For example, the housing of the wearable device 101 may include one or more straps that is able to be twined around the head of the user 110 and/or one or more temples attachable to an ear of the head.

Referring to FIG. 2A, according to an embodiment of the disclosure, a wearable device 101 may include at least one display 250 and a frame 200 supporting the at least one display 250.

According to an embodiment of the disclosure, the wearable device 101 may be wearable on a body part of the user 110. The wearable device 101 may provide augmented reality (AR), virtual reality (VR), or mixed reality (MR) combining the augmented reality and the virtual reality to the user 110 wearing the wearable device 101. For example, the wearable device 101 may display a virtual reality image provided from at least one optical device 282 and 284 of FIG. 2B on at least one display 250, in response to a user 110's preset gesture obtained through a motion recognition camera 260-2 and 260-3 of FIG. 2B.

According to an embodiment of the disclosure, the at least one display 250 may provide visual information to a user 110. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user 110's left and right eyes, respectively.

Referring to FIG. 2B, the at least one display 250 may provide visual information transmitted through a lens included in the at least one display 250 from ambient light to a user 110 and other visual information distinguished from the visual information. The lens may be formed based on at least one of a Fresnel lens, a pancake lens, or a multi-channel lens. For example, the at least one display 250 may include a first surface 231 and a second surface 232 opposite to the first surface 231. A display area may be formed on the second surface 232 of at least one display 250. When the user 110 wears the wearable device 101, ambient light may be transmitted to the user 110 by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

In an embodiment of the disclosure, the at least one display 250 may include at least one waveguide 233 and 234 that transmits light transmitted from the at least one optical device 282 and 284 by diffracting to the user 110. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 101 to guide a screen displayed by the at least one display 250 to the user 110's eyes. For example, the screen may be transmitted to the user 110's eyes based on total internal reflection (TIR) generated in the at least one waveguide 233 and 234.

The wearable device 101 may analyze an object included in a real image collected through a photographing camera 260-4, combine with a virtual object corresponding to an object that become a subject of augmented reality provision among the analyzed object, and display on the at least one display 250. The virtual object may include at least one of text and images for various information associated with the object included in the real image. The wearable device 101 may analyze the object based on a multi-camera, such as a stereo camera. For the object analysis, the wearable device 101 may execute space recognition (e.g., simultaneous localization and mapping (SLAM)) using the multi-camera and/or time-of-flight (ToF). The user 110 wearing the wearable device 101 may watch an image displayed on the at least one display 250.

According to an embodiment of the disclosure, a frame 200 may be configured with a physical structure in which the wearable device 101 may be worn on the user 110's body. According to an embodiment of the disclosure, the frame 200 may be configured so that when the user 110 wears the wearable device 101, the first display 250-1 and the second display 250-2 may be positioned corresponding to the user 110's left and right eyes. The frame 200 may support the at least one display 250. For example, the frame 200 may support the first display 250-1 and the second display 250-2 to be positioned at positions corresponding to the user 110's left and right eyes.

Referring to FIG. 2A, according to an embodiment of the disclosure, the frame 200 may include an area 220 at least partially in contact with the portion of the user 110's body in case that the user 110 wears the wearable device 101. For example, the area 220 of the frame 200 in contact with the portion of the user 110's body may include an area in contact with a portion of the user 110's nose, a portion of the user 110's ear, and a portion of the side of the user 110's face that the wearable device 101 contacts. According to an embodiment of the disclosure, the frame 200 may include a nose pad 210 that is contacted on the portion of the user 110's body. When the wearable device 101 is worn by the user 110, the nose pad 210 may be contacted on the portion of the user 110's nose. The frame 200 may include a first temple 204 and a second temple 205, which are contacted on another portion of the user 110's body that is distinct from the portion of the user 110's body.

For example, the frame 200 may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's ear, and the second temple 205 extending from the second rim 202 and fixed to a portion of the ear opposite to the ear. The first pad 211 and the second pad 212 may be in contact with the portion of the user 110's nose, and the first temple 204 and the second temple 205 may be in contact with a portion of the user 110's face and the portion of the user 110's ear. The temples 204 and 205 may be rotatably connected to the rim through hinge units 206 and 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment of the disclosure, the wearable device 101 may identify an external object (e.g., a user 110's fingertip) touching the frame 200 and/or a gesture performed by the external object by using a touch sensor, a grip sensor, and/or a proximity sensor formed on at least a portion of the surface of the frame 200.

According to an embodiment of the disclosure, the wearable device 101 may include hardware (e.g., hardware described below based on the block diagram of FIG. 4) that performs various functions. For example, the hardware may include a battery module 270, an antenna module 275, the at least one optical device 282 and 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). Various hardware may be disposed in the frame 200.

According to an embodiment of the disclosure, the microphone (e.g., the microphones 265-1, 265-2, and 265-3) of the wearable device 101 may obtain a sound signal, by being disposed on at least a portion of the frame 200. The first microphone 265-1 disposed on the bridge 203, the second microphone 265-2 disposed on the second rim 202, and the third microphone 265-3 disposed on the first rim 201 are illustrated in FIG. 2B, but the number and disposition of the microphone 265 are not limited to an embodiment of FIG. 2B. In case that the number of the microphone 265 included in the wearable device 101 is two or more, the wearable device 101 may identify a direction of the sound signal by using a plurality of microphones disposed on different portions of the frame 200.

According to an embodiment of the disclosure, the at least one optical device 282 and 284 may project a virtual object on the at least one display 250 in order to provide various image information to the user 110. For example, the at least one optical device 282 and 284 may be a projector. The at least one optical device 282 and 284 may be disposed adjacent to the at least one display 250 or may be included in the at least one display 250 as a portion of the at least one display 250. According to an embodiment of the disclosure, the wearable device 101 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to the first waveguide 233 disposed on the first display 250-1, and the second optical device 284 may transmit light to the second waveguide 234 disposed on the second display 250-2.

In an embodiment of the disclosure, a camera 260 may include the photographing camera 260-4, an eye tracking camera (ET CAM) 260-1, and/or the motion recognition camera 260-2 and 260-3. The photographing camera 260-4, the eye tracking camera 260-1, and the motion recognition camera 260-2 and 260-3 may be disposed at different positions on the frame 200 and may perform different functions. The eye tracking camera 260-1 may output data indicating a position of eye or a gaze of the user 110 wearing the wearable device 101. For example, the wearable device 101 may detect the gaze from an image including the user 110's pupil obtained through the eye tracking camera 260-1. The wearable device 101 may identify an object (e.g., a real object, and/or a virtual object) focused by the user 110, by using the user 110's gaze obtained through the eye tracking camera 260-1. The wearable device 101 identifying the focused object may execute a function (e.g., gaze interaction) for interaction between the user 110 and the focused object. The wearable device 101 may represent a portion corresponding to eye of an avatar indicating the user 110 in the virtual space, by using the user 110's gaze obtained through the eye tracking camera 260-1. The wearable device 101 may render an image (or a screen) displayed on the at least one display 250, based on the position of the user 110's eye. For example, visual quality (e.g., resolution, brightness, saturation, grayscale, and pixels per inch (PPI)) of a first area related to the gaze within the image and visual quality of a second area distinguished from the first area may be different. In this disclosure, the term “resolution” is used to refer to the density of pixels in an image and/or display. The density and/or resolution of pixels may be measured based on a unit of PPI and/or dot performance (dpi), or may be parameterized. The wearable device 101 may obtain an image having the visual quality of the first area matching the user 110's gaze and the visual quality of the second area by using foveated rendering. For example, when the wearable device 101 supports an iris recognition function, user authentication may be performed based on iris information obtained using the eye tracking camera 260-1. An example in which the eye tracking camera 260-1 is disposed toward the user 110's right eye is illustrated in FIG. 2B, but the embodiment is not limited thereto, and the eye tracking camera 260-1 may be disposed alone toward the user 110's left eye or may be disposed toward two eyes.

In an embodiment of the disclosure, the photographing camera 260-4 may photograph a real image or background to be matched with a virtual image in order to implement the augmented reality or mixed reality content. The photographing camera 260-4 may be used to obtain an image having a high resolution based on a high resolution (HR) or a photo video (PV). The photographing camera 260-4 may photograph an image of a specific object existing at a position viewed by the user 110 and may provide the image to the at least one display 250. The at least one display 250 may display one image in which a virtual image provided through the at least one optical device 282 and 284 is overlapped with information on the real image or background including an image of the specific object obtained by using the photographing camera 260-4. The wearable device 101 may compensate for depth information (e.g., a distance between the wearable device 101 and an external object obtained through a depth sensor), by using an image obtained through the photographing camera 260-4. The wearable device 101 may perform object recognition through an image obtained using the photographing camera 260-4. The wearable device 101 may perform a function (e.g., auto focus) of focusing an object (or subject) within an image and/or an optical image stabilization (OIS) function (e.g., an anti-shaking function) by using the photographing camera 260-4. While displaying a screen representing a virtual space on the at least one display 250, the wearable device 101 may perform a pass through function for displaying an image obtained through the photographing camera 260-4 overlapping at least a portion of the screen. In an embodiment of the disclosure, the photographing camera 260-4 may be disposed on the bridge 203 disposed between the first rim 201 and the second rim 202.

The eye tracking camera 260-1 may implement a more realistic augmented reality by matching the user 110's gaze with the visual information provided on the at least one display 250, by tracking the gaze of the user 110 wearing the wearable device 101. For example, when the user 110 looks at the front, the wearable device 101 may naturally display environment information associated with the user 110's front on the at least one display 250 at a position where the user 110 is positioned. The eye tracking camera 260-1 may be configured to capture an image of the user 110's pupil in order to determine the user 110's gaze. For example, the eye tracking camera 260-1 may receive gaze detection light reflected from the user 110's pupil and may track the user 110's gaze based on the position and movement of the received gaze detection light.

In an embodiment of the disclosure, the eye tracking camera 260-1 may be disposed at a position corresponding to the user 110's left and right eyes. For example, the eye tracking camera 260-1 may be disposed in the first rim 201 and/or the second rim 202 to face the direction in which the user 110 wearing the wearable device 101 is positioned.

The motion recognition camera 260-2 and 260-3 may provide a specific event to the screen provided on the at least one display 250 by recognizing the movement of the whole or portion of the user 110's body, such as the user 110's torso, hand, or face. The motion recognition camera 260-2 and 260-3 may obtain a signal corresponding to motion by recognizing the user 110's motion (e.g., gesture recognition), and may provide a display corresponding to the signal to the at least one display 250. The processor may identify a signal corresponding to the operation and may perform a preset function based on the identification. The motion recognition camera 260-2 and 260-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 260-2 and 260-3. In an embodiment of the disclosure, the motion recognition camera 260-2 and camera 260-3 may be disposed on the first rim 201 and/or the second rim 202.

The camera 260 included in the wearable device 101 is not limited to the above-described eye tracking camera 260-1 and the motion recognition camera 260-2 and 260-3. For example, the wearable device 101 may identify an external object included in a field of view (FoV) by using a camera disposed toward the user 110's FoV. The wearable device 101 identifying the external object may be performed based on a sensor for identifying a distance between the wearable device 101 and the external object, such as a depth sensor and/or a time of flight (ToF) sensor. The camera 260 disposed toward the FoV may support an autofocus function (AF) and/or an optical image stabilization (OIS) function. For example, in order to obtain an image including a face of the user 110 wearing the wearable device 101, the wearable device 101 may include the camera 260 (e.g., a face tracking (FT) camera) disposed toward the face.

Although not illustrated, the wearable device 101 according to an embodiment may further include a light source (e.g., light emitting diode (LED)) that emits light toward a subject (e.g., user 110's eyes, face, and/or an external object in the FoV) photographed by using the camera 260. The light source may include an LED having an infrared wavelength. The light source may be disposed on at least one of the frame 200, and the hinge units 206 and 207.

According to an embodiment of the disclosure, the battery module 270 may supply power to electronic components of the wearable device 101. In an embodiment of the disclosure, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment of the disclosure, the battery module 270 may be disposed at an end of the first temple 204 and/or the second temple 205.

The antenna module 275 may transmit the signal or power to the outside of the wearable device 101 or may receive the signal or power from the outside. In an embodiment of the disclosure, the antenna module 275 may be disposed in the first temple 204 and/or the second temple 205. For example, the antenna module 275 may be disposed close to one surface of the first temple 204 and/or the second temple 205.

The speaker 255 may output a sound signal to the outside of the wearable device 101. A sound output module may be referred to as a speaker. In an embodiment of the disclosure, the speaker 255 may be disposed in the first temple 204 and/or the second temple 205 in order to be disposed adjacent to the ear of the user 110 wearing the wearable device 101. For example, the speaker 255 may include a second speaker 255-2 disposed adjacent to the user 110's left ear by being disposed in the first temple 204, and a first speaker 255-1 disposed adjacent to the user 110's right ear by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the wearable device 101 to the user 110. For example, when the wearable device 101 requires charging, it may emit red light at a constant cycle. In an embodiment of the disclosure, the light emitting module may be disposed on the first rim 201 and/or the second rim 202.

Referring to FIG. 2B, according to an embodiment of the disclosure, the wearable device 101 may include the printed circuit board (PCB) 290. The PCB 290 may be included in at least one of the first temple 204 or the second temple 205. The PCB 290 may include an interposer disposed between at least two sub PCBs. On the PCB 290, one or more hardware (e.g., hardware illustrated by blocks of FIG. 4) included in the wearable device 101 may be disposed. The wearable device 101 may include a flexible PCB (FPCB) for interconnecting the hardware.

According to an embodiment of the disclosure, the wearable device 101 may include at least one of a gyro sensor, a gravity sensor, and/or an acceleration sensor for detecting the posture of the wearable device 101 and/or the posture of a body part (e.g., a head) of the user 110 wearing the wearable device 101. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment of the disclosure, the wearable device 101 may identify the user 110's motion and/or gesture performed to execute or stop a specific function of the wearable device 101 based on the IMU.

FIGS. 3A and 3B illustrate an exterior of a wearable device according to various embodiments of the disclosure.

The wearable device 101 of FIGS. 3A and 3B may be an example of the electronic device 101 of FIG. 1, the wearable device 101 of FIGS. 2A and 2B. According to an embodiment of the disclosure, an example of an exterior of a first surface 310 of a housing of the wearable device 101 may be illustrated in FIG. 3A, and an example of an exterior of a second surface 320 opposite to a first surface 310 may be illustrated in FIG. 3B.

Referring to FIG. 3A, according to an embodiment of the disclosure, the first surface 310 of the wearable device 101 may have an attachable shape on the user 110's body part (e.g., the user 110's face). Although not illustrated, the wearable device 101 may further include a strap for being fixed on the user 110's body part, and/or one or more temples (e.g., the first temple 204 and/or the second temple 205 of FIGS. 2A and 2B). A first display 250-1 for outputting an image to the left eye among the user 110's two eyes and a second display 250-2 for outputting an image to the right eye among the user 110's two eyes may be disposed on the first surface 310. The wearable device 101 may further include rubber or silicon packing, which are formed on the first surface 310, for preventing interference by light (e.g., ambient light) different from the light emitted from the first display 250-1 and the second display 250-2.

According to an embodiment of the disclosure, the wearable device 101 may include cameras 260-1 for photographing and/or tracking two eyes of the user 110 adjacent to each of the first display 250-1 and the second display 250-2. The cameras 260-1 may be referred to as the gaze tracking camera 260-1 of FIG. 2B. According to an embodiment of the disclosure, the wearable device 101 may include cameras 260-5 and 260-6 for photographing and/or recognizing the user 110's face. The cameras 260-5 and 260-6 may be referred to as a FT camera. The wearable device 101 may control an avatar representing the user 110 in a virtual space, based on a motion of the user 110's face identified using the cameras 260-5 and 260-6. For example, the wearable device 101 may change a texture and/or a shape of a portion (e.g., a portion of an avatar representing a human face) of the avatar, by using information obtained by the cameras 260-5 and 260-6 (e.g., the FT camera) and representing the facial expression of the user 110 wearing the wearable device 101.

Referring to FIG. 3B, a camera (e.g., cameras 260-7, 260-8, 260-9, 260-10, 260-11, and 260-12), and/or a sensor (e.g., the depth sensor 330) for obtaining information associated with the external environment of the wearable device 101 may be disposed on the second surface 320 opposite to the first surface 310 of FIG. 3A. For example, the cameras 260-7, 260-8, 260-9, and 260-10 may be disposed on the second surface 320 in order to recognize an external object. The cameras 260-7, 260-8, 260-9, and 260-10 may be referred to as the motion recognition cameras 260-2 and 260-3 of FIG. 2B.

For example, by using cameras 260-11 and 260-12, the wearable device 101 may obtain an image and/or video to be transmitted to each of the user 110's two eyes. The camera 260-11 may be disposed on the second surface 320 of the wearable device 101 to obtain an image to be displayed through the second display 250-2 corresponding to the right eye among the two eyes. The camera 260-12 may be disposed on the second surface 320 of the wearable device 101 to obtain an image to be displayed through the first display 250-1 corresponding to the left eye among the two eyes. The cameras 260-11 and 260-12 may be referred to as the photographing camera 260-4 of FIG. 2B.

According to an embodiment of the disclosure, the wearable device 101 may include the depth sensor 330 disposed on the second surface 320 in order to identify a distance between the wearable device 101 and the external object. By using the depth sensor 330, the wearable device 101 may obtain spatial information (e.g., a depth map) about at least a portion of the FoV of the user 110 wearing the wearable device 101. Although not illustrated, a microphone for obtaining sound outputted from the external object may be disposed on the second surface 320 of the wearable device 101. The number of microphones may be one or more according to embodiments.

Hereinafter, a hardware or software configuration of the wearable device 101 will be described later with reference to FIG. 4.

FIG. 4 illustrates a block diagram of a wearable device according to an embodiment of the disclosure.

The wearable device 101 of FIG. 4 may be an example of the electronic device 101 of FIG. 1 and the wearable device 101 of FIGS. 2A, 2B, 3A, and 3B.

Referring to FIG. 4, the wearable device 101 according to an embodiment may include a processor 410, memory 415, a display 250 (e.g., the first display 250-1 and/or the second display 250-2 of FIGS. 2A, 2B, 3A, and 3B) and/or a sensor 420. The processor 410, the memory 415, the display 250, and the sensor 420 may be electrically and/or operably connected to each other by an electronic component, such as a communication bus 402. In the disclosure, an operational connection of electronic components may include a direct connection established between the electronic components and/or an indirect connection established between the electronic components such that a first electronic component of the electronic components is controlled by a second electronic component of the electronic components. The type and/or number of electronic components included in the wearable device 101 is not limited as illustrated in FIG. 4. For example, the wearable device 101 may include only some of the electronic components illustrated in FIG. 4.

According to an embodiment of the disclosure, the processor 410 of the wearable device 101 may include circuitry (e.g., processing circuitry) for processing data, based on one or more instructions. For example, the circuitry for processing data may include an arithmetic and logic unit (ALU), a field programmable gate array (FPGA), a central processing unit (CPU) and/or an application processor (AP). In an embodiment of the disclosure, the wearable device 101 may include one or more processors. According to an embodiment of the disclosure, a structure of the processor 410 is not limited to an embodiment of the disclosure, and at least one circuit may be formed as a separate processor (e.g., embedded secure element (eSE), secure processor) physically separated outside the processor 410. The processor 410 may have a structure of a multi-core processor, such as a dual core, a quad core, a hexa core, and/or an octa core. The multi-core processor structure of the processor 410 may include a structure (e.g., a big-little structure) based on a plurality of core circuits, divided by power consumption, clock, and/or computational amount per unit time. In an embodiment including the processor 410 having a multi-core processor structure, operations and/or functions of the disclosure may be performed individually or collectively by one or more cores included in the processor 410.

According to an embodiment of the disclosure, the memory 415 of the wearable device 101 may include an electronic component for storing data and/or instructions inputted to the processor 410 and/or outputted from the processor 410. For example, the memory 415 may include volatile memory, such as random-access memory (RAM) and/or non-volatile memory, such as read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, hard disk, compact disc, and embedded multi-media card (eMMC). In an embodiment of the disclosure, the memory 415 may be referred to as a storage.

In an embodiment of the disclosure, the display 250 of the wearable device 101 may output visualized information to a user 110 of the wearable device 101. The display 250 arranged in front of eyes of the user 110 wearing the wearable device 101 may be disposed in at least a portion of a housing of the wearable device 101 (e.g., the first display 250-1 and/or the second display 250-2 of FIGS. 2A, 2B, 3A, and 3B). For example, the display 250 may output visualized information to the user 110 by being controlled by the processor 410 including a circuit, such as a CPU, a graphics processing unit (GPU), and/or a display processing unit (DPU). The display 250 may include a flexible display, a flat panel display (FPD) and/or electronic paper. The display 250 may include a liquid crystal display (LCD), a plasma display panel (PDP), and/or one or more light emitting diode (LED). The LED may include an organic LED (OLED). The embodiment is not limited thereto, and for example, the display 250 may include a projector (or projection assembly) for projecting light onto the lens when the wearable device 101 includes a lens for transmitting external light (or ambient light). In an embodiment of the disclosure, the display 250 may be referred to as a display panel and/or a display module. Pixels included in the display 250 may be disposed toward any one of the user 110's two eyes when worn by the user 110 of the wearable device 101. For example, the display 250 may include display areas (or active areas) corresponding to each of the user 110's two eyes.

In an embodiment of the disclosure, the sensor 420 of the wearable device 101 may generate electronic information capable of being processed by the processor 410 and/or the memory 415 from non-electronic information associated with the wearable device 101. For example, the sensor 420 may include a global positioning system (GPS) sensor for detecting a geographic location of the wearable device 101. In addition to the GPS method, the sensor 420 may generate information indicating a geographical location of the wearable device 101 based on a global navigation satellite system (GNSS), such as Galileo, Beidou, or Compass). The information may be stored in the memory 415, processed by the processor 410, and/or transmitted to another electronic device distinct from the wearable device 101 via a communication circuit.

Referring to FIG. 4, as an example of the sensor 420 included in the wearable device 101, the image sensor 421 and/or the motion sensor 422 are illustrated. The sensor 420 may include one or more optical sensors (e.g., a charged coupled device (CCD) sensor and a complementary metal oxide semiconductor (CMOS) sensor) that generate an electrical signal indicating a color and/or brightness of light. The image sensor 421 may be referred to as a camera. The plurality of optical sensors included in the image sensor 421 may be disposed in a form of a 2-dimensional array. The image sensor 421 may substantially simultaneously obtain electrical signals of each of the plurality of optical sensors to generate 2-dimensional frame data corresponding to light reaching optical sensors of the 2-dimensional array. For example, photographic data captured using the image sensor 421 may mean a 2-dimensional frame data obtained from the image sensor 421. For example, video data captured using the image sensor 421 may mean a sequence of the plurality of 2-dimensional frame data obtained from the image sensor 421 according to a frame rate. The image sensor 421 may further include a flash light, disposed toward a direction in which the image sensor 421 receives light and outputting light toward the direction.

According to an embodiment of the disclosure, the wearable device 101 may include a plurality of image sensors disposed in different directions, as an example of the image sensor 421. As described above with reference to FIGS. 2A, 2B, 3A, and 3B, the plurality of image sensors may include a gaze tracking camera (e.g., the gaze tracking cameras 260-1 of FIGS. 2B and 3A) configured to be arranged toward eyes of a user 110 wearing the wearable device 101. The plurality of image sensors may include an outward camera. The processor 410 may identify a direction of the user 110's gaze by using an image and/or a video obtained from the gaze tracking camera. The gaze tracking camera may include an infrared (IR) sensor. The gaze tracking camera may be referred to as an eye sensor and/or an eye tracker.

The outward camera may be disposed toward the front of the user 110 wearing the wearable device 101 (e.g., a direction to which two eyes may be directed). The wearable device 101 may include a plurality of outward cameras. The embodiment is not limited thereto, and the outward camera may be disposed toward an external space. The processor 410 may identify an external object by using an image and/or a video obtained from the outward camera. For example, the processor 410 may identify a position, shape, and/or gesture (e.g., hand gesture) of a hand of the user 110 wearing the wearable device 101, based on an image and/or a video obtained from the outward camera. Using an image and/or a video of the external environment, obtained from the outward camera, the processor 410 may recognize or track one or more objects in the external environment.

According to an embodiment of the disclosure, the motion sensor 422 may output an electric signal indicating gravitational acceleration, acceleration, and/or angular velocity of a plurality of axes (e.g., x-axis, y-axis, and z-axis), which are perpendicular to each other and based on an origin designated in the wearable device 101 and/or the motion sensor 422. For example, the processor 410 may repeatedly receive or obtain, from the motion sensor 422, sensor data including accelerations, angular velocities, and/or magnitudes of a magnetic field of the number of the plurality of axes, based on a designated period (e.g., 1 millisecond). In an embodiment of the disclosure, the motion sensor 422 may be referred to as an inertial measurement unit (IMU). The sensor 420 included in the wearable device 101 is not limited to the above description, and may include a grip sensor, a proximity sensor, a heart rate sensor, a fingerprint sensor, an illumination sensor, and/or a ToF sensor. Using the motion sensor 422, the processor 410 may detect motion of the wearable device 101 (e.g., motion of the wearable device 101 caused by the user 110 wearing the wearable device 101).

In an embodiment of the disclosure, a communication circuit (not illustrated) of the wearable device 101 may include a hardware component for supporting a transmission and/or reception of signals between the wearable device 101 and an external electronic device (e.g., the external electronic device 102 or the external electronic device 104). For example, the communication circuit may include at least one of a modem, an antenna, and an optic/electronic (O/E) converter. The communication circuit 430 may support the transmission and/or reception of electrical signals, based on various types of protocols, such as Ethernet, local area network (LAN), wide area network (WAN), wireless fidelity (Wi-Fi), Bluetooth, Bluetooth low energy (BLE), Zigbee, long term evolution (LTE), and 5G new radio (NR).

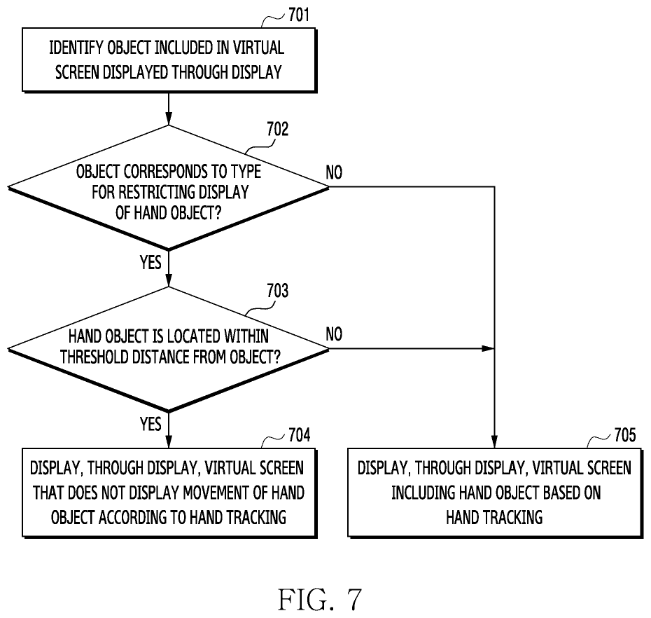

According to an embodiment of the disclosure, one or more instructions (or commands) indicating data to be processed by the processor 410 of the wearable device 101, calculations and/or operations to be performed may be stored in the memory 415 of the wearable device 101. A set of one or more instructions may be referred to as a program, firmware, operating system, process, routine, sub-routine, and/or software application (hereinafter referred to as application). For example, the wearable device 101 and/or the processor 410 may perform at least one of operations of FIGS. 7, 9, and 11, when a set of a plurality of instruction distributed in the form of an operating system, firmware, driver, program, and/or software application is executed. Hereinafter, a software application being installed within the wearable device 101 may mean that one or more instructions provided in the form of a software application (or package) are stored in the memory 415, and that the one or more applications are stored in an executable format (e.g., a file with an extension designated by the operating system of the wearable device 101) by the processor 410. As an example, the application may include a program and/or a library, associated with a service provided to the user 110.

Referring to FIG. 4, programs installed in the wearable device 101 may be included in any one among different layers including an application layer 440, a framework layer 450, and/or a hardware abstraction layer (HAL) S, based on a target. For example, programs (e.g., module or driver) designed to target a hardware (e.g., the display 250, and/or the sensor 420) of the wearable device 101 may be included in the hardware abstraction layer 480 (e.g., android system HAL, and/or extended reality (XR) HAL). In terms of including one or more programs for providing an extended reality (XR) service, the framework layer 450 may be referred to as an XR framework layer. For example, the layers illustrated in FIG. 4, which are logically separated (or for convenience of explanation), may not mean that an address space of the memory 415 is divided by the layers.

For example, programs (e.g., a location tracker 471, a space recognizer 472, a gesture tracker 473, a gaze tracker 474, a face tracker 475, and/or a renderer 490) designed to target at least one of the hardware abstraction layer 480 and/or the application layer 440 may be included within framework layer 450. Programs included in the framework layer 450 may provide an application programming interface (API) capable of being executed (or called) based on other programs.

For example, a program designed to target the user 110 of the wearable device 101 may be included in the application layer 440. An extended reality (XR) system user interface (UI) 441 and/or an XR application 442 are illustrated as an example of programs included in the application layer 440, but embodiments are not limited thereto. For example, programs (e.g., software application) included in the application layer 440 may cause execution of a function supported by programs included in the framework layer 450, by calling the API.

For example, the wearable device 101 may display, on the display 250, one or more visual objects for performing interaction with the user 110, based on the execution of the XR system UI 441. The visual object may mean an object capable of being positioned within a screen for transmission of information and/or interaction, such as text, image, icon, video, button, check box, radio button, text box, slider and/or table. The visual object may be referred to as a visual guide, a virtual object, a visual element, a UI element, a view object, and/or a view element. The wearable device 101 may provide functions available in a virtual space to the user 110, based on the execution of the XR system UI 441.

Referring to FIG. 4, it is described that the XR system UI 441 includes a lightweight renderer 443 and/or an XR plug-in 444 but is not limited thereto. For example, the processor 410 may execute the lightweight renderer 443 and/or the XR plug-in 444 in the framework layer 450, based on the XR system UI 441.

For example, the wearable device 101 may obtain a resource (e.g., API, system process, and/or library) used to define, create, and/or execute a rendering pipeline in which partial changes are allowed, based on the execution of the lightweight renderer 443. The lightweight renderer 443 may be referred to as a lightweight renderer pipeline in terms of defining a rendering pipeline in which partial changes are allowed. The lightweight renderer 443 may include a renderer (e.g., a prebuilt renderer) built before execution of a software application. For example, the wearable device 101 may obtain a resource (e.g., API, system process, and/or library) used to define, create, and/or execute the entire rendering pipeline, based on the execution of the XR plug-in 444. The XR plug-in 444 may be referred to as an open XR native client in terms of defining (or setting) the entire rendering pipeline.

For example, the wearable device 101 may display a screen representing at least a portion of a virtual space on the display 250, based on the execution of the XR application 442. The XR plug-in 444-1 included in the XR application 442 may include instructions supporting a function similar to the XR plug-in 444 of the XR system UI 441. Among descriptions of the XR plug-in 444-1, a description overlapping those of the XR plug-in 444 may be omitted. The wearable device 101 may cause execution of a virtual space manager 451, based on execution of the XR application 442.

For example, the wearable device 101 may display an image in a virtual space on the display 250, based on execution of an application 445. The application 445 may be configured to output image information for displaying a two-dimensional image. The wearable device 101 may cause execution of the virtual space manager 451, based on execution of the application 445. The wearable device 101 may create double image information to represent the two-dimensional image in a three-dimensional virtual space, based on the execution of the application 445. Herein, the double image information may include first image information for the left eye and second image information for the right eye, based on binocular disparity. In order to represent the two-dimensional image in the three-dimensional virtual space, the wearable device 101 may create the double image information, based on image information for displaying the two-dimensional image.

According to an embodiment of the disclosure, the wearable device 101 may provide a virtual space service, based on the execution of the virtual space manager 451. For example, the virtual space manager 451 may include a platform for supporting a virtual space service. Based on the execution of the virtual space manager 451, the wearable device 101 may identify a virtual space formed based on a user 110's location indicated by data obtained through the sensor 420, and may display at least a portion of the virtual space on the display 250. The virtual space manager 451 may be referred to as a composition presentation manager (CPM).

For example, the virtual space manager 451 may include a runtime service 452. As an example, the runtime service 452 may be referred to as an OpenXR runtime module (or OpenXR runtime program). The wearable device 101 may execute at least one of a user 110's pose prediction function, a frame timing function, and/or a space input function, based on the execution of the runtime service 452. As an example, the wearable device 101 may perform rendering for a virtual space service to the user 110, based on the execution of the runtime service 452. For example, based on the execution of runtime service 452, a function associated with a virtual space executable by the application layer 440 may be supported.

For example, the virtual space manager 451 may include a pass-through manager 453. The wearable device 101 may display, while displaying a screen representing a virtual space on display 250, based on the execution of the pass-through manager 453, an image and/or a video representing an actual space obtained through an external camera superimposed on at least a portion of the screen.

For example, the virtual space manager 451 may include an input manager 454. The wearable device 101 may identify data (e.g., sensor data) obtained by executing one or more programs included in a perception service layer 470, based on the execution of the input manager 454. The wearable device 101 may identify a user input associated with the wearable device 101, by using the obtained data. The user input may be associated with the user 110's motion (e.g., hand gesture), gaze, and/or speech identified by the sensor 420 (e.g., the image sensor 421, such as an external camera). The user input may be identified based on an external electronic device connected (or paired) through a communication circuit.

For example, a perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstraction layer 460 may be referred to as OpenPX. The perception abstraction layer 460 may be used for a perception client and a perception service.

According to an embodiment of the disclosure, the perception service layer 470 may include one or more programs for processing data obtained from the sensor 420. One or more programs may include at least one of the location tracker 471, the space recognizer 472, the gesture tracker 473, the gaze tracker 474, and/or the face tracker 475, and/or the renderer 490. The type and/or number of one or more programs included in the perception service layer 470 is not limited as illustrated in FIG. 4.

For example, the wearable device 101 may identify a posture of the wearable device 101 by using the sensor 420, based on the execution of the location tracker 471. The wearable device 101 may identify 6 degrees of freedom pose (6 dof pose) of the wearable device 101, based on the execution of the location tracker 471, by using data obtained using an external camera (e.g., the image sensor 421) and/or an IMU (e.g., motion sensor 422 including gyro sensor, acceleration sensor and/or geomagnetic sensor). The location tracker 471 may be referred to as a head tracking (HeT) module (or a head tracker or head tracking program).

For example, the wearable device 101 may obtain information for providing a three-dimensional virtual space corresponding to a surrounding environment (e.g., external space) of the wearable device 101 (or the user 110 of the wearable device 101), based on the execution of the space recognizer 472. The wearable device 101 may reproduce the surrounding environment of the wearable device 101 in three dimensions, by using data obtained using an external camera (e.g., the image sensor 421) based on the execution of the space recognizer 472. The wearable device 101 may identify at least one of a plane, an inclination, and a step, based on the surrounding environment of the wearable device 101 reproduced in three dimensions based on the execution of the space recognizer 472. The space recognizer 472 may be referred to as a scene understanding (SU) module (or a scene recognition program).

For example, the wearable device 101 may identify (or recognize) a hand's pose and/or gesture of the user 110 of the wearable device 101 based on the execution of the gesture tracker 473. For example, the wearable device 101 may identify a pose and/or a gesture of the user 110's hand by using data obtained from an external camera (e.g., the image sensor 421), based on the execution of the gesture tracker 473. As an example, the wearable device 101 may identify a pose and/or a gesture of the user 110's hand, based on data (or image) obtained using an external camera based on the execution of the gesture tracker 473. The gesture tracker 473 may be referred to as a hand tracking (HaT) module (or a hand tracking program) and/or a gesture tracking module.

For example, the wearable device 101 may identify (or track) the movement of the user 110's eyes of the wearable device 101, based on the execution of the gaze tracker 474. For example, the wearable device 101 may identify the movement of the user 110's eyes, by using data obtained from a gaze tracking camera (e.g., the image sensor 421) based on the execution of the gaze tracker 474. The gaze tracker 474 may be referred to as an eye tracking (ET) module (or eye tracking program) and/or a gaze tracking module.

For example, the perception service layer 470 of the wearable device 101 may further include the face tracker 475 for tracking the user 110's face. For example, the wearable device 101 may identify (or track) the movement of the user 110's face and/or the user 110's facial expression, based on the execution of the face tracker 475. The wearable device 101 may estimate the user 110's facial expression, based on the movement of the user 110's face based on the execution of the face tracker 475. For example, the wearable device 101 may identify the movement of the user 110's face and/or the user 110's facial expression, based on data (e.g., image and/or video) obtained using a camera (e.g., FT camera, a camera facing at least a portion of the user 110's face, and the image sensor 421), based on the execution of the face tracker 475. The face tracker 475 may be referred to as a face tracking (FT) (or a face tracking program) and/or a face tracking module.

Referring to FIG. 4, the renderer 490 may include instructions for rendering images in a 3-dimensional virtual space. The processor 410 executing the renderer 490 may obtain at least one image to be displayed at least partially in a display area of the display 250 in a software application. For example, the processor 410 executing the renderer 490 may determine a location of an area to which an application (e.g., XR application 442, application 445) is to be rendered. The processor 410 executing the renderer 490 may create an image of the application to be displayed on the display 250. The renderer 490 may synthesize the images to create a composite image to be displayed on the display 250.

For example, the processor 410 executing the renderer 490 may divide a display area of the display 250 into a foveated portion (or may be referred to as a foveated area) and a peripheral portion (or may be referred to as a remaining area), by using a gaze location calculated using the location tracker 471 and/or the gaze tracker 474. For example, the processor 410 detecting coordinate values of the gaze location may determine a portion of the display area including the coordinate values as a foveated area. The DPU executing the renderer 490 may obtain at least one image, corresponding to each of the foveated area and the remaining area, and having a size smaller than a size of the entire display area of the display 250 or a resolution less than a resolution of the display area.

For example, the processor 410 executing the renderer 490 may obtain or create a composite image to be displayed on the display 250, by synthesizing an image corresponding to the foveated area and an image corresponding to a peripheral portion. For example, the processor 410 may enlarge the image corresponding to the peripheral portion to a size of the entire display area of the display 250, by performing upscaling. The processor 410 may create a composite image to be displayed on the display 250, by combine the image corresponding to the foveated area onto the enlarged image. The processor 410 may mix the enlarged image and the image corresponding to the foveated area, by applying a visual effect, such as blur along a boundary line of the image corresponding to the foveated area.

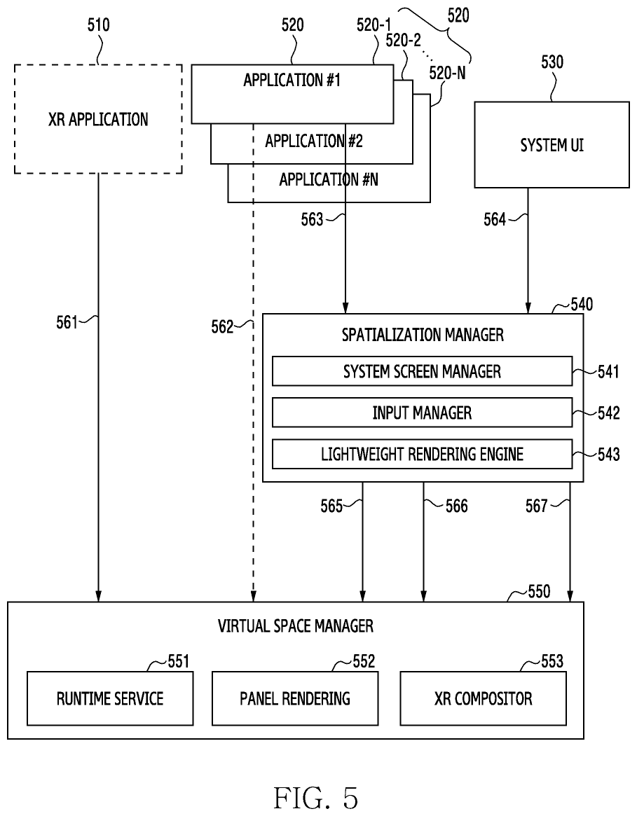

FIG. 5 illustrates a block diagram of a wearable device (e.g., the electronic device 101 of FIG. 1, the wearable device 101 of FIGS. 2A, 2B, 3A, 3B, and 4) for displaying an image in a virtual space according to an embodiment of the disclosure.

In FIG. 5, an example in which a plurality of programs/instructions for displaying an image in a virtual space is executed is described. The plurality of programs/instructions) may all be executed in one processor (e.g., AP) or may be executed by a plurality of processors (e.g., AP, graphic processing unit (GPU), neural processing unit (NPU)). The meaning of being executable by the plurality of processors may indicate that a portion of programs/instructions may be executed by a first processor and another portion of programs/instructions may be executed by a second processor different from the first processor.

Referring to FIG. 5, the wearable device 101 may execute a virtual space manager 550 (e.g., the virtual space manager 451 and the CPM of FIG. 4) to render an image in a virtual space. For the virtual space manager 550, descriptions of the virtual space manager 451 of FIG. 4 may be at least partially referenced. The virtual space manager 550 may include a platform for supporting a virtual space service. The virtual space manager 550 may include a runtime service 551 (e.g., OpenXR Runtime), a panel renderer 552 (e.g., two-dimensional (2D) Panel Render), and an XR compositor 553. The wearable device 101 may execute at least one of the user 110's pose prediction function, a frame timing function, and/or a space input function, based on the execution of the runtime service 551. For the runtime service 551, descriptions of the runtime service 452 of FIG. 4 may be at least partially referenced. The wearable device 101 may display at least one image (video) on a panel (e.g., a 2D panel) to implement a virtual space through the display, based on the execution of the panel renderer 552. For example, the wearable device 101 may display a rendering image corresponding to RGB information 566 for a panel from a spatialization manager 540 to be described later via a display (e.g., display 250). The wearable device 101 may synthesize an image of an actual area captured through a camera in a virtual space (hereinafter, a pass-through image) and a virtual area image, based on the execution of the XR compositor 553. For example, the wearable device 101 may create a composite image, by merging the pass-through image and the virtual area image, based on the execution of the XR compositor 553. The wearable device 101 may transmit the created composite image to a display buffer so that the composite image is displayed. The wearable device 101 may identify the virtual space through the virtual space manager 550, and display at least a portion of the virtual space on the display 250. The virtual space manager 550 may be referred to as the CPM. The wearable device 101 may execute the virtual space manager 550 to render an image corresponding to at least a portion of the virtual space.

According to an embodiment of the disclosure, the wearable device 101 may execute the spatialization manager 540. The spatialization manager 540 may perform processes for displaying an image in a three-dimensional virtual space. The wearable device 101 may perform preprocessing based on the execution of the spatialization manager 540 so that an image may be rendered in a three-dimensional virtual space through the virtual space manager 550. For example, the wearable device 101 may perform at least some of functions of the renderer 490 of FIG. 4, based on the execution of the spatialization manager 540. Based on the execution of the spatialization manager 540, the wearable device 101 may process image information provided by an application (e.g., the XR application 510, an application 520 providing a normal two-dimensional screen other than XR, and an application providing a system UI 530).

For example, the spatialization manager 540 (e.g., Space Flinger) may include a system screen manager 541 (e.g., System scene), an input manager L (e.g., Input Routing), and a lightweight rendering engine 543 (e.g., Impress Engine). The system screen manager 541 may be executed to display the system UI 530. System UI-related information 564 may be transmitted from a program (e.g., API) providing the system UI 530 to the system screen manager 541. The system UI-related information 564 may be obtained via a spatializer API and/or a Same-process private API. The spatialization manager 540 may determine a layout (e.g., location, display order) of a screen of the system UI 530 in a three-dimensional space, through pre-allocated resources. The system screen manager 541 may transmit image information 567 for rendering a screen of the system UI 530 to the virtual space manager 550, according to the layout. The input manager 542 may be configured to process a user input (e.g., user input on a system screen or an app screen). The input manager 542 may map a user input recognized by the sensor 420 of the wearable device 101 to at least one of one or more software applications (e.g., the XR application 510, an application 520 providing a normal two-dimensional screen other than XR, and an application providing the system UI 530) mapped to the virtual space by the spatialization manager 540. For example, mapping of a user input may include executing instructions (e.g., sub-routine and/or event handler) of a software application for processing the user input. The lightweight rendering engine 543 may be a renderer (e.g., the lightweight renderer 443) for image generation. For example, the lightweight rendering engine 543 may be used to display the system UI 530. According to an embodiment of the disclosure, the spatialization manager 540 may include the lightweight rendering engine 543 for rendering the system UI. According to an embodiment of the disclosure, when the lightweight rendering engine 543 does not have enough resources to render an avatar used in the HMD, at least one external rendering engine may be used. In this case, an external rendering engine support module may be added inside the spatialization manager 540 to address the compatibility issue with external rendering (e.g., 3rd party engine).

According to an embodiment of the disclosure, the electronic device may execute an application. For example, the virtual space manager 550 may be executed in response to the execution of the XR application 510 (e.g., the XR application 442, a three-dimensional (3D) game, an XR map, and other immersive applications). The wearable device 101 may provide the virtual space manager 550 with double image information 561 provided from the XR application 510. In order to display an image in a 3D space, the double image information 561 may include two image information considering binocular parallax. For example, in order to render in a 3-dimensional virtual space, the double image information 561 may include first image information for the user 110's left eye and second image information for the user 110's right eye. Hereinafter, in the disclosure, double image information is used as a term referring to image information for indicating images for two eyes in a 3-dimensional space. In addition to the double image information, binocular image information, double image data, double image, binocular image data, stereoscopic image information, 3D image information, spatial image information, spatial image data, 2D-3D conversion data, dimensional conversion image data, binocular parallax image data, and/or equivalent technical terms may be used. The wearable device 101 may generate a composite image by merging image layers through the virtual space manager 550. The wearable device 101 may transmit the generated composite image to a display buffer. The composite image may be displayed on the display 250 of the wearable device 101.

According to an embodiment of the disclosure, the electronic device may execute at least one of an application 520 (e.g., first application 520-1, second application 520-2, . . . , and Nth application 520-N) different from the XR application 510. According to an embodiment of the disclosure, the application 520 may be configured to output image information for displaying a two-dimensional (2D) image (e.g., window and/or activity). In other words, the application 520 may provide a two-dimensional image. As an example, the application 520 may be an image application, a schedule application, or an Internet browser application. When the image information 562 provided from the application 520 is provided to the virtual space manager 550 in response to the execution of the application 520, since the image information 562 has only the x-coordinate and y-coordinate in the two-dimensional plane, it may be difficult to consider the order of precedence (i.e., a distance separated from the user 110) between other applications centered on the user 110. Even when displaying the application 520 providing a general 2D screen, the wearable device 101 may execute the spatialization manager 540 to provide double image information to the virtual space manager 550. For example, the wearable device 101 may receive application-related information 563 from the first application 520-1, based on the execution of the spatialization manager 540. For example, the application-related information 563 may include image information (e.g., information including RGB per pixel) indicating a two-dimensional image of the first application 520-1 and/or content information (e.g., characteristic of content executed in the first application, type of content) in the first application 520-1. The application-related information 563 may be obtained through a spatializer API. Based on the execution of the spatialization manager 540, the wearable device 101 may identify a location of an area in which the first application 520-1 is to be rendered and information (hereinafter, location information) on a size of the area to be rendered. Based on the execution of the spatialization manager 540, the wearable device 101 may create double image information 565 (e.g., RGBx2) in which the user 110's binocular disparity is considered, through the image information and the location information. Based on the execution of the spatialization manager 540, the wearable device 101 may provide the double image information 565 to the virtual space manager 550. By converting a simple two-dimensional image into the double image information 565, a problem occurring when the image information 562 is directly transmitted to the virtual space manager 550 may be addressed. In addition, as at least some of functions for image display in a virtual space are performed by the spatialization manager 540 instead of the virtual space manager 550, the burden on the virtual space manager 550 may be reduced.

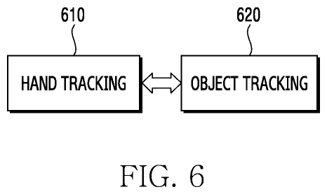

FIG. 6 is a block diagram illustrating an operation of a wearable device performing object tracking and hand tracking according to an embodiment of the disclosure.

Referring to FIG. 6, the wearable device 101 according to an embodiment may perform hand tracking 610 and object tracking 620. For example, the wearable device 101 may display a hand object within a virtual screen displayed through the display 250, based on data on the user 110's hand ((e.g., hand location data, hand angle data, hand joint location data, hand joint angle data, hand gesture data, hand shape data, or a combination thereof) obtained according to the hand tracking 610 using the camera 260 and/or the sensor 420. For example, the wearable device 101 may display an object (or a virtual object) within a virtual screen displayed through the display 250, based on data on an object (e.g., objects location data, objects angle data, object type data, or a combination thereof) obtained according to the object tracking 620 using the camera 260 and/or the sensor 420.

When the hand tracking 610 and the object tracking 620 are independently performed, a problem may occur in which personal information (e.g., a password) of the user 110 is leaked or an action unintended by the user 110 is performed. In an example, when the user 110 wearing the wearable device 101 inputs a password through an input means of an automated teller machine (ATM), the password of the user 110 may be leaked to a third party by the hand tracking 610 and the object tracking 620. In an example, while the user 110 wearing the wearable device 101 controls the actual keyboard, an action unintended by the user 110 (e.g., virtual keyboard control) may be performed by a hand object displayed on the virtual screen.

In order to prevent personal information leakage or the action unintended by the user 110, information of an object (e.g., object type, attribute) obtained during the object tracking 620 may be used for the hand tracking 610. Below, a device and a method for preventing personal information leakage or an action unintended by the user 110 are described by omitting or changing a process of the hand tracking 610 according to the information of the object obtained during the object tracking 620.

FIG. 7 is a flowchart illustrating an operation of a wearable device for restricting a display of a user's hand object in a virtual screen according to an embodiment of the disclosure.

Operations of FIG. 7 may be performed by the electronic device 101 of FIG. 1 and the wearable device 101 of FIGS. 2A, 2B, 3A, 3B, and 4. For example, at least a portion of the operations may be controlled by the processor 410 of the wearable device 101. In the following embodiment of the disclosure, each operation may be performed sequentially, but is not necessarily performed sequentially. For example, the sequence of each operation may be changed. For example, at least two operations may be performed in parallel.

Referring to FIG. 7, in operation 701, the wearable device 101 according to an embodiment may identify an object included in a virtual screen displayed through the display 250.

In an embodiment of the disclosure, the wearable device 101 may obtain an image of a surrounding environment by using the camera 260 and/or the sensor 420. The image may include an image of an object (or a peripheral object or an external object) outside the wearable device 101. The wearable device 101 may perform object recognition based on an image obtained using the camera 260 and/or the sensor 420. For example, object recognition may be performed based on identifying features (e.g., boundary, corner, edge) of the object included in the image.

In an embodiment of the disclosure, the wearable device 101 may perform object tracking on the identified object. For example, the wearable device 101 may generate object tracking data, based on object tracking. For example, object tracking data may include object location data, object angle data, object type data, or a combination thereof.

In operation 702, the wearable device 101 according to an embodiment may identify whether an object included in a virtual screen corresponds to a type for restricting a display (or representation) of the hand object of the user 110.

In an embodiment of the disclosure, the wearable device 101 may identify a type of an object included in a virtual screen displayed through the display 250 based on the object type data. The object type may mean a criterion for classifying objects based on a category. In an example, the object type may correspond to an object type of one of an automated teller machine (ATM), a door lock, a keyboard, and a mouse. However, this is only an example, and the disclosure is not limited thereto. For example, the object type may further include object types belonging to different categories, and the above exemplified object types (e.g., keyboard and mouse) may be divided into one object type (e.g., input means) based on a higher category. For example, the object type may be replaced by object classification, object category, object type, object group, object class, or other terms with an equivalent technical meaning.

In an embodiment of the disclosure, the wearable device 101 may generate object attribute data, based on the object type. For example, the attribute data may display one of attributes associated with an interaction between an object and the hand object of the user 110. In an example, the attribute may be specified for the object type. In an example, the attribute may be identified based on an artificial intelligence model of the wearable device 101 that uses the object type as input data. For example, attributes may include a first attribute, a second attribute, and a third attribute. However, the disclosure is not limited thereto. For example, the attributes may include only some of the first attribute, the second attribute, and the third attribute.

In an embodiment of the disclosure, the first attribute may indicate that an interaction between an object and the hand object of the user 110 is prohibited. In an example, an object type having the first attribute may include an ATM and a door lock. However, the disclosure is not limited thereto. When hand tracking data according to hand tracking and/or object tracking data according to object tracking are provided to an application, a system, and/or an external electronic device, the object type having the first attribute may include an object type through which personal information (or security information or password) of the user 110 may be leaked. In order to prevent the leakage of personal information of the user 110, the object type having the first attribute may be restricted from displaying the hand object of the user 110 within the virtual screen displayed through the display 250 of the wearable device 101.

In an embodiment of the disclosure, the second attribute may indicate that the interaction between an object and the hand object of the user 110 is restricted. In an example, an object type having the second attribute may include a keyboard and a mouse. However, the disclosure is not limited thereto. The object type having the second attribute may include an object type capable of interacting with the user 110's hand (e.g., actual hand). For example, while the user 110 controls input means (e.g., real keyboard and/or real mouse) using hand, an unintended action (e.g., control of virtual keyboard and/or virtual mouse) may occur due to a hand object displayed on the virtual screen of the wearable device 101. In order to prevent an unintended action from occurring by the user 110, the object type having the second attribute may have an interaction with a hand object of the user 110 restricted within a virtual screen displayed through the display 250 of the wearable device 101.

In an embodiment of the disclosure, the third attribute may indicate that the interaction between an object and the hand object of the user 110 is not restricted. An object type having the third attribute may interact with the hand object of the user 110 within the virtual screen displayed on the display 250 of the wearable device 101.

In operation 703, in a case of operation 702—YES (e.g., the object corresponds a type to restrict the display of the hand object), the wearable device 101 according to an embodiment may identify whether the hand object is located within a threshold distance (e.g., 1 meter) from the object within the virtual screen. For example, the wearable device 101 may identify whether the hand object is located within a threshold distance from the object within the virtual screen, in accordance with the identification that the object included in the virtual screen corresponds to a type (e.g., the object type having the first attribute) to restrict the display (or representation) of the hand object of the user 110.

In operation 704, in a case of operation 703—YES (e.g., the hand object is located within the threshold distance from the object), the wearable device 101 according to an embodiment may display, through the display 250, a virtual screen that does not display a movement of the hand object of the user 110 according to the hand tracking. For example, the wearable device 101 may display, through the display 250, a virtual screen that does not display a movement of the hand object according to the hand tracking, based on the identification that the hand object is located within the threshold distance from the object within the virtual screen.

In an embodiment of the disclosure, the wearable device 101 may not perform hand tracking in order not to display the movement of the hand object according to the hand tracking. Since the hand tracking is not performed by the wearable device 101, the hand tracking data may not be generated. Since the hand tracking data is not generated, the hand object of the user 110 may not be displayed on the virtual screen of the wearable device 101. Since the hand object is not displayed on the virtual screen of the wearable device 101, leakage of personal information of the user 110 displayed according to the hand movement of the user 110 may be prevented.

In an embodiment of the disclosure, the wearable device 101 may generate hand tracking data based on the hand tracking. The hand tracking data may include hand location data, hand angle data, hand joint location data, hand joint angle data, hand gesture data, hand shape data, or a combination thereof. However, the disclosure is not limited thereto. For example, the hand tracking data may include only some of the data described above.

In an embodiment of the disclosure, the wearable device 101 may refrain from providing hand tracking data generated according to the hand tracking to an application, a system, and/or an external electronic device, in order not to display the movement of the hand object according to the hand tracking. For example, the wearable device 101 may identify that a display of a hand object located within a threshold distance from the object is restricted based on attribute data of the object. The wearable device 101 may refrain from providing the hand tracking data to the application, the system, and/or the external electronic device, based on the identification that the display of the hand object within the virtual screen is restricted. Since the hand tracking data of the user 110 is not provided to the application, the system, and/or the external electronic device, the hand object may not be displayed through the display 250 of the wearable device 101. Since the hand tracking data is not provided to the application, the system, and/or the external electronic device, the leakage of the user 110's personal information displayed according to the hand movement of the user 110 may be prevented.

In an embodiment of the disclosure, the wearable device 101 may display, through a virtual screen, a hand object having a default gesture in order not to display the movement of the hand object according to the hand tracking. For example, the wearable device 101 may identify that the display of the hand object located within the threshold distance from the object is restricted, based on the attribute data of the object. The wearable device 101 may display, through the virtual screen, the hand object having the default gesture, based on the identification that the display of the hand object within the virtual screen is restricted. For example, the wearable device 101 may not use hand angle data, hand joint location data, hand joint angle data, hand gesture data, and hand shape data, for the hand tracking. Since the data is not used for the hand tracking, the hand object displayed through virtual screen may have the default gesture. In an example, the default gesture may correspond to a first gesture. However, this is only an example and the disclosure is not limited thereto. For example, the default gesture may mean an arbitrary gesture having a fixed hand posture (or shape). Since the hand object having the default gesture does not display the hand movement of the user 110, leakage of personal information of the user 110 displayed according to the hand movement of the user 110 may be prevented.

In an embodiment of the disclosure, the wearable device 101 may generate hand tracking data that is different from the hand movement of the user 110, in order not to display the movement of the hand object according to the hand tracking. For example, hand tracking data different from the movement of the user 110's hand may be referred to as dummy data or other terms having equivalent technical meaning. For example, the wearable device 101 may identify that the display of the hand object located within the threshold distance from the object is restricted, based on the attribute data of the object. The wearable device 101 may generate other data different from the hand tracking data according to hand tracking, based on the identification that the display of the hand object is restricted within the virtual screen. For example, the wearable device 101 may generate other data that is different from the hand location data, the hand angle data, the hand joint location data, the hand joint angle data of, the hand gesture data, and the hand shape data, which are generated according to the hand tracking. In an example, since other data different from the hand location data generated according to the hand tracking is generated, a location of the hand object displayed on the virtual screen may be different from a location of the hand of the user 110. In an example, since other data different from the hand angle data, the hand joint location data, the hand joint angle data, the hand gesture data, and the hand shape data generated according to the hand tracking are generated, a posture (or shape) of the hand object displayed on the virtual screen of the wearable device 101 may be different from a posture (or shape) of the hand of the user 110. Since the location and/or posture of the hand of the user 110 and the location and/or posture of the hand object displayed by the data generated by the wearable device 101 are different, the leakage of personal information of the user 110 displayed according to the hand movement of the user 110 may be prevented.

In operation 705, in a case of operation 702—NO (e.g., the object does not correspond to a type for restricting the display of the hand object) or operation 703-NO (e.g., the hand object is located outside the threshold distance from the object), the wearable device 101 according to an embodiment may display, through the display 250, a virtual screen including the hand object of the user 110 based on hand tracking. For example, the wearable device 101 may display, through the display 250, a virtual screen including a hand object of the user 110 based on the hand tracking, in accordance with the identification that the object included in the virtual screen does not correspond to a type for restricting the display (or, representation) of the hand object of the user 110. In another example, the wearable device 101 may display, through the display 250, a virtual screen including the hand object of the user 110 based on hand tracking, in accordance with the identification that the hand object is located outside the threshold distance from the object within the virtual screen.

In an embodiment of the disclosure, the wearable device 101 may identify whether the object corresponds to a type in which an interaction with the hand object of the user 110 is restricted. For example, the wearable device 101 may refrain from controlling the virtual object using the hand object displayed on the virtual screen based on the hand tracking data, in accordance with the identification that the object corresponds to a type in which the interaction with the hand object of the user 110 is restricted. In another example, the wearable device 101 may control the virtual object using the hand object displayed on the virtual screen based on the hand tracking data, in accordance with the identification that the object does not correspond to a type in which the interaction with the hand object of the user 110 is restricted.

FIGS. 8A, 8B, and 8C illustrate an operation of a wearable device for restricting a display of a user's hand object in a virtual screen according to various embodiments of the disclosure.

FIGS. 8A, 8B, and 8C illustrate not displaying a movement of a hand object in accordance with hand tracking within a virtual screen, when the user 110 inputs a password (e.g., 1523) through an input means of an automated teller machine (ATM) 802.

Referring to FIG. 8A, the user 110 may input, through the input means of the ATM 802, a first number (e.g., 1) of the password at a first time, a second number (e.g., 5) of the password at a second time, a third number (e.g., 2) of the password at a third time, and a fourth number (e.g., 3) of the password at a fourth time, by a movement of the hand 801. For example, the wearable device 101 may display an image of the ATM 802 obtained using the camera 260 and/or the sensor 420 within the virtual screen. In another example, the ATM 802 may be shown to the user 110 through a lens included in the display 250 of the wearable device 101. The wearable device 101 may identify a designated attribute for the object type of the ATM 802. The designated attribute for the object type of the ATM 802 may indicate that the display of the hand object within the virtual screen displayed through the display 250 of the wearable device 101 is restricted. For example, the wearable device 101 may not perform hand tracking based on the identification that the ATM 802 corresponds to an object type in which the display (or representation) of the hand object is restricted. In another example, the wearable device 101 may refrain from providing hand tracking data generated by the hand tracking to an application and/or system, based on the identification that the ATM 802 corresponds to an object type in which the display of the hand object is restricted. For example, the hand tracking data generated by the hand tracking may be processed in a trusted execution environment (TEE). For example, the hand tracking data may be processed in a secure area. In an example, the secure area may be a separate area configured within the processor 410 for security. In another example, the secure area may be a separate area (e.g., embedded secure element (eSE), secure processor) configured outside the processor 410 for security. In still another example, the security area may be implemented based on software (e.g., a hypervisor). Since hand tracking is not performed or hand tracking data is not provided to the application and/or system, the wearable device 101 may not display the hand object within the virtual screen displayed via the display 250. For example, the wearable device 101 may not display a hand object 812 that presses the first number (e.g., 1) of the password on a first virtual screen 811 displayed through the display 250. For example, the wearable device 101 may not display a hand object 814 that presses the second number (e.g., 5) of the password on a second virtual screen 813 displayed through the display 250. For example, the wearable device 101 may not display a hand object 816 that presses the third number (e.g., 2) of the password on a third virtual screen 815 displayed through the display 250. For example, the wearable device 101 may not display a hand object 818 that presses the fourth number (e.g., 3) of the password on a fourth virtual screen 817 displayed through the display 250. Since the hand objects are not displayed through the display 250 while the user 110 inputs the password using the hand 801, the leakage of the user 110's password displayed according to the movement of the user 110's hand 801 may be prevented.

Referring to FIG. 8B, the user 110 may input, through the input means of the ATM 802, a first number (e.g., 1) of the password at a first time, a second number (e.g., 5) of the password at a second time, a third number (e.g., 2) of the password at a third time, and a fourth number (e.g., 3) of the password at a fourth time, by the movement of the hand 801. For example, the wearable device 101 may display an image of the ATM 802 obtained using the camera 260 and/or the sensor 420 within the virtual screen. In another example, the ATM 802 may be shown to the user 110 through a lens included in the display 250 of the wearable device 101. The wearable device 101 may identify a designated attribute for the object type of the ATM 802. The designated attribute for the object type of the ATM 802 may indicate that the display of the hand object is restricted within the virtual screen displayed through the display 250 of the wearable device 101. The wearable device 101 may display a hand object having a default gesture (or fixed gesture) on the virtual screen, based on the identification that the ATM 802 corresponds to an object type in which the display of the hand object is restricted. The hand object having the default gesture may differ from a gesture (or posture, shape) of the user 110's hand 801. For example, the wearable device 101 may display a hand object 822 having the default gesture different from the gesture of the user 110's hand 801 on a first virtual screen 821, while the user 110 presses the first number (e.g., 1) of the password using the hand 801. For example, the wearable device 101 may display a hand object 824 having the default gesture different from the gesture of the user 100's hand 801 on a second virtual screen 823, while the user 110 presses the second number (e.g., 5) of the password using the hand 801. For example, the wearable device 101 may display a hand object 826 having the default gesture different from the gesture of the user 100's hand 801 on a third virtual screen 825, while the user 110 presses the third number (e.g., 2) of the password using the hand 801. For example, the wearable device 101 may display a hand object 828 having the default gesture different from the gesture of the user 100's hand 801 on a fourth virtual screen 827, while the user 110 presses the fourth number (e.g., 3) of the password using the hand 801. Since hand objects having the default gesture different from the gesture of the user 100's hand 801 pressing the password are displayed on the virtual screen, the leakage of the password displayed according to the movement of the user 110's hand 801 may be prevented.

Referring to FIG. 8C, the user 110 may input, through the input means of the ATM 802, a first number (e.g., 1) of the password at a first time, a second number (e.g., 5) of the password at a second time, a third number (e.g., 2) of the password at a third time, and a fourth number (e.g., 3) of the password at a fourth time by the movement of the hand 801. For example, the wearable device 101 may display an image of the ATM 802 obtained using the camera 260 and/or the sensor 420 within the virtual screen. In another example, the ATM 802 may be shown to the user 110 through a lens included in the display 250 of the wearable device 101. The wearable device 101 may identify a designated attribute for the object type of the ATM 802. The designated attribute for the object type of the ATM 802 may indicate that the display of the hand object is restricted within the virtual screen displayed through the display 250 of the wearable device 101. The wearable device 101 may generate hand tracking data (or dummy data) different from the movement of the user 100's hand 801, based on the identification that the ATM 802 corresponds to an object type in which the display of the hand object is restricted. For example, the wearable device 101 may identify that the user 110 is pressing the first number (e.g., 1) of the password using the hand 801, based on the hand tracking. The wearable device 101 may display a hand object 832 pressing another number (e.g., 2) different from the first number on a virtual screen 831, based on the identification. For example, the wearable device 101 may identify that the user 110 is pressing the second number (e.g., 5) of the password using the hand 801, based on the hand tracking. The wearable device 101 may display a hand object 834 pressing another number (e.g., 1) different than the second number on a virtual screen 833, based on the identification. For example, the wearable device 101 may identify that the user 110 is pressing the third number (e.g., 2) of the password using the hand 801, based on the hand tracking. The wearable device 101 may display a hand object 836 pressing another number (e.g., 4) different than the third number on a virtual screen 835, based on the identification. For example, the wearable device 101 may identify that the user 110 is pressing the fourth number (e.g., 3) of the password using the hand 801, based on the hand tracking. The wearable device 101 may display a hand object 838 pressing another number (e.g., 1) different than the fourth number on a virtual screen 837, based on the identification. Since hand objects that press a password different from a password inputted by the hand 801 of the user 110 are displayed on the virtual screen of the wearable device 101, the leakage of the password displayed according to the hand movement of the user 110 may be prevented.

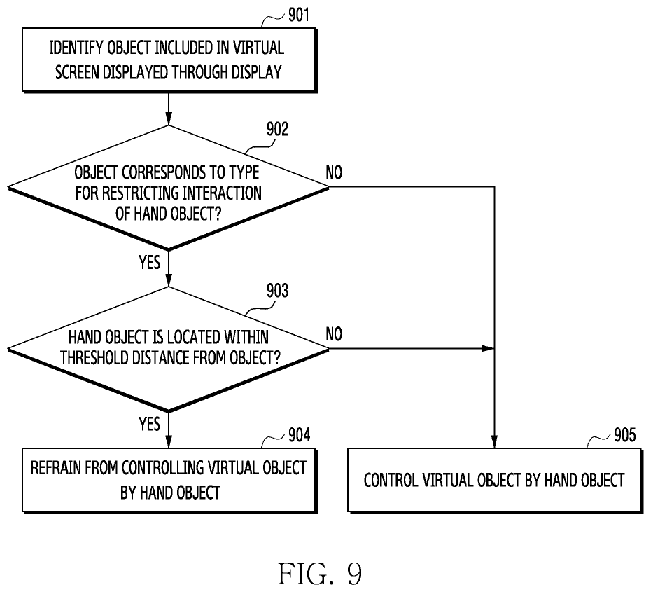

FIG. 9 is a flowchart illustrating an operation of a wearable device for restricting an interaction of a user's hand object in a virtual screen according to an embodiment of the disclosure.

Operations of FIG. 9 may be performed by the electronic device 101 of FIG. 1, or the wearable device 101 of FIGS. 2A, 2B, 3A, 3B, and 4. For example, at least a portion of the operations may be controlled by the processor 410 of the wearable device 101. In the following embodiment of the disclosure, each operation may be performed sequentially, but is not necessarily performed sequentially. For example, the sequence of each operation may be changed. For example, at least two operations may be performed in parallel.

Referring to FIG. 9, in operation 901, the wearable device 101 according to an embodiment may identify an object included in a virtual screen displayed through the display 250.

In an embodiment of the disclosure, the wearable device 101 may obtain an image of a surrounding environment by using the camera 260 and/or the sensor 420. The image may include an image of an object outside the wearable device 101 (or a peripheral object, or an external object). The wearable device 101 may perform object recognition based on the image obtained using the camera 260 and/or the sensor 420. For example, the object recognition may be performed based on identifying features (e.g., boundary, corner, edge) of the object included in the image.

In an embodiment of the disclosure, the wearable device 101 may perform object tracking for the identified object. For example, the wearable device 101 may generate object tracking data based on the object tracking. For example, the object tracking data may include object location data, object angle data, object type data, or a combination thereof.

In operation 902, the wearable device 101 according to an embodiment may identify whether an object included in the virtual screen corresponds to a type for restricting interaction with the hand object of the user 110.

In an embodiment of the disclosure, the wearable device 101 may identify a type of an object included in a virtual screen displayed through the display 250 based on the object type data. The object type may mean a criterion for classifying objects based on a category. In an example, the object type may correspond to an object type of one of an automated teller machine (ATM), a door lock, a keyboard, and a mouse. However, this is only an example, and the disclosure is not limited thereto. For example, the object type may further include object types belonging to different categories, and the above exemplified object types (e.g., keyboard and mouse) may be divided into one object type (e.g., input means) based on a higher category. For example, the object type may be replaced by object classification, object category, object type, object group, object class, or other terms with an equivalent technical meaning.

In an embodiment of the disclosure, the wearable device 101 may generate object attribute data, based on the object type. For example, the attribute data may display one of attributes associated with an interaction between an object and the hand object of the user 110. In an example, the attribute may be specified for the object type. In an example, the attribute may be identified based on an artificial intelligence model of the wearable device 101 that uses the object type as input data. For example, attributes may include a first attribute, a second attribute, and a third attribute. However, the disclosure is not limited thereto. For example, the attributes may include only some of the first attribute, the second attribute, and the third attribute.

In an embodiment of the disclosure, the first attribute may indicate that an interaction between an object and the hand object of the user 110 is prohibited. In an example, an object type having the first attribute may include an ATM and a door lock. However, the disclosure is not limited thereto. When hand tracking data according to hand tracking and/or object tracking data according to object tracking are provided to an application, a system, and/or an external electronic device, the object type having the first attribute may include an object type through which personal information (or security information or password) of the user 110 may be leaked. In order to prevent the leakage of personal information of the user 110, the object type having the first attribute may be restricted from displaying the hand object of the user 110 within the virtual screen displayed through the display 250 of the wearable device 101.

In an embodiment of the disclosure, the second attribute may indicate that the interaction between an object and the hand object of the user 110 is restricted. In an example, an object type having the second attribute may include a keyboard and a mouse. However, the disclosure is not limited thereto. The object type having the second attribute may include an object type capable of interacting with the user 110's hand (e.g., actual hand). For example, while the user 110 controls input means (e.g., real keyboard and/or real mouse) using hand, an unintended action (e.g., control of virtual keyboard and/or virtual mouse) may occur due to a hand object displayed on the virtual screen. In order to prevent an unintended action from occurring by the user 110, the object type having the second attribute may have an interaction with a hand object of the user 110 restricted within a virtual screen displayed through the display 250 of the wearable device 101.

In an embodiment of the disclosure, the third attribute may indicate that the interaction between an object and the hand object of the user 110 is not restricted. An object type having the third attribute may interact with the hand object of the user 110 within the virtual screen displayed on the display 250 of the wearable device 101.

In operation 903, in a case of operation 903—YES (e.g., the object corresponds a type to restrict the interaction of the hand object), the wearable device 101 according to an embodiment may identify whether the hand object is located within a threshold distance (e.g., 1 cm) from the object within the virtual screen. For example, the wearable device 101 may identify whether the hand object is located within a threshold distance from the object within the virtual screen, in accordance with the identification that the object included in the virtual screen corresponds to a type (e.g., the object type having the second attribute) to restrict the interaction of the hand object of the user 110.

In operation 904, in a case of operation 903—YES (e.g., the hand object is located within the threshold distance from the object), the wearable device 101 according to an embodiment may refrain from controlling the virtual object using the hand object displayed through the display 250. For example, the wearable device 101 may refrain from controlling the virtual object using the hand object displayed through the display 250, based on the identification that the hand object is located within the threshold distance from the object within the virtual screen. By refraining from controlling the virtual object using the hand object, performing an unintended action by the user 110 may be prevented.

In operation 905, in a case of operation 902—NO (e.g., the object does not correspond to a type for restricting interaction with the hand object) or operation 903—NO (e.g., the hand object is located outside the threshold distance from the object), the wearable device 101 according to an embodiment may control the virtual object using the hand object displayed through the display 250. For example, the wearable device 101 may control the virtual object using the hand object displayed through the display 250, based on the identification that the object included in the virtual screen does not correspond to a type for restricting interaction with the hand object of the user 110. In another example, the wearable device 101 may control the virtual object using the hand object displayed within the virtual screen based on the identification that the hand object is located outside the threshold distance from the object within the virtual screen.

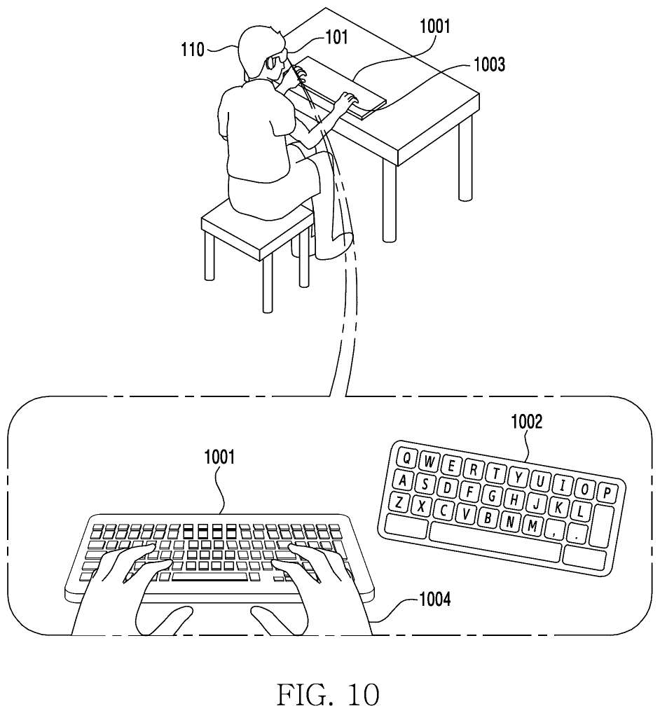

FIG. 10 illustrates restrictions of an interaction by a user's hand object in a virtual screen according to an embodiment of the disclosure.

FIG. 10 illustrates a virtual keyboard 1002 is not controlled by a hand object 1004 displayed on a virtual screen, while a user 110 controls an actual keyboard 1001 using a hand 1003.

Referring to FIG. 10, the user 110 may control the actual keyboard 1001 through a movement of the hand 1003. The wearable device 101 may display, within the virtual screen, an image of the actual keyboard 1001 obtained using the camera 260 and/or the sensor 420 and an image of the virtual keyboard 1002. The wearable device 101 may identify a designated attribute for the actual keyboard 1001. The designated attribute for the object type of the keyboard may indicate that interaction by the hand object 1004 displayed on the virtual screen is restricted. The wearable device 101 may identify whether the hand object 1004 is located within a threshold distance (e.g., 10 cm) from the actual keyboard 1001, based on the identification that the actual keyboard 1001 corresponds to an object type for restricting interaction of the hand object. For example, the wearable device 101 may refrain from controlling the virtual keyboard 1002 using the hand object 1004, based on the identification that the hand object 1004 is located within the threshold distance from the actual keyboard 1001. In another example, the wearable device 101 may control the virtual keyboard 1002 using the hand object 1004, based on the identification that the hand object 1004 is located outside the threshold distance from the actual keyboard 1001.

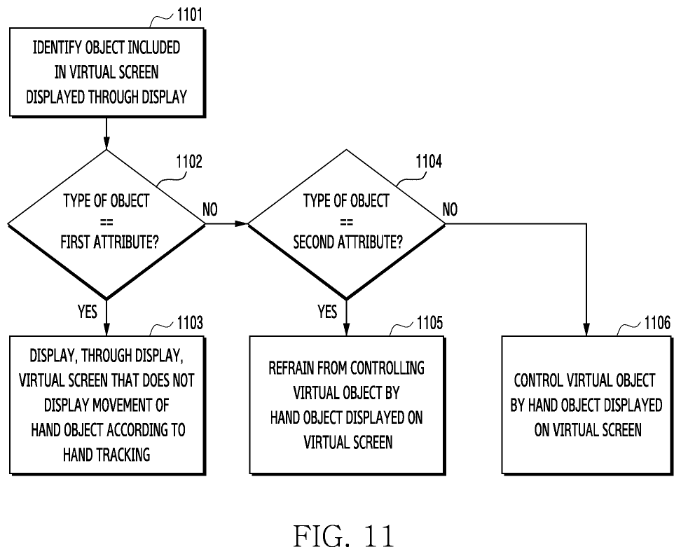

FIG. 11 is a flowchart illustrating an operation of a wearable device for processing a hand object in a virtual screen in accordance with a type of an object in a virtual screen according to an embodiment of the disclosure.

The operations of FIG. 11 may be performed by the electronic device 101 of FIG. 1 or the wearable device 101 of FIGS. 2A, 2B, 3A, 3B, and 4. For example, at least a portion of the operations may be controlled by the processor 410 of the wearable device 101. In the following embodiment of the disclosure, each operation may be performed sequentially, but is not necessarily performed sequentially. For example, the sequence of each operation may be changed. For example, at least two operations may be performed in parallel.

Referring to FIG. 11, in operation 1101, the wearable device 101 according to an embodiment may identify an object included in a virtual screen displayed through the display 250.

In an embodiment of the disclosure, the wearable device 101 may obtain an image of a surrounding environment by using the camera 260 and/or the sensor 420. The image may include an image of an object outside the wearable device 101 (or a peripheral object, or an external object). The wearable device 101 may perform object recognition based on the image obtained using the camera 260 and/or the sensor 420. For example, the object recognition may be performed based on identifying features (e.g., boundary, corner, edge) of the object included in the image.

In an embodiment of the disclosure, the wearable device 101 may perform object tracking for the identified object. For example, the wearable device 101 may generate object tracking data based on the object tracking. For example, the object tracking data may include object location data, object angle data, object type data, or a combination thereof.

In operation 1102, the wearable device 101 according to an embodiment may identify whether a type of an object corresponds to a first attribute.

In an embodiment of the disclosure, the wearable device 101 may identify a type of an object included in a virtual screen displayed through the display 250 based on the object type data. The object type may mean a criterion for classifying objects based on a category. In an example, the object type may correspond to an object type of one of an automated teller machine (ATM), a door lock, a keyboard, and a mouse. However, this is only an example, and the disclosure is not limited thereto. For example, the object type may further include object types belonging to different categories, and the above exemplified object types (e.g., keyboard and mouse) may be divided into one object type (e.g., input means) based on a higher category. For example, the object type may be replaced by object classification, object category, object type, object group, object class, or other terms with an equivalent technical meaning.

In an embodiment of the disclosure, the wearable device 101 may generate object attribute data, based on the object type. For example, the attribute data may display one of attributes associated with an interaction between an object and the hand object of the user 110. In an example, the attribute may be specified for the object type. In an example, the attribute may be identified based on an artificial intelligence model of the wearable device 101 that uses the object type as input data. For example, attributes may include a first attribute, a second attribute, and a third attribute. However, the disclosure is not limited thereto. For example, the attributes may include only some of the first attribute, the second attribute, and the third attribute.

In an embodiment of the disclosure, the first attribute may indicate that an interaction between an object and the hand object of the user 110 is prohibited. In an example, an object type having the first attribute may include an ATM and a door lock. However, the disclosure is not limited thereto. When hand tracking data according to hand tracking and/or object tracking data according to object tracking are provided to an application, a system, and/or an external electronic device, the object type having the first attribute may include an object type through which personal information (or security information or password) of the user 110 may be leaked. In order to prevent the leakage of personal information of the user 110, the object type having the first attribute may be restricted from displaying the hand object of the user 110 within the virtual screen displayed through the display 250 of the wearable device 101.

In an embodiment of the disclosure, the second attribute may indicate that the interaction between an object and the hand object of the user 110 is restricted. In an example, an object type having the second attribute may include a keyboard and a mouse. However, the disclosure is not limited thereto. The object type having the second attribute may include an object type capable of interacting with the user 110's hand (e.g., actual hand). For example, while the user 110 controls input means (e.g., real keyboard and/or real mouse) using hand, an unintended action (e.g., control of virtual keyboard and/or virtual mouse) may occur due to a hand object displayed on the display 250 of the wearable device 101. In order to prevent an unintended action from occurring by the user 110, the object type having the second attribute may have an interaction with a hand object of the user 110 restricted within a virtual screen displayed through the display 250 of the wearable device 101.

In an embodiment of the disclosure, the third attribute may indicate that the interaction between an object and the hand object of the user 110 is not restricted. An object type having the third attribute may interact with the hand object of the user 110 within the virtual screen displayed on the display 250 of the wearable device 101.

In operation 1103, in a case of operation 1102—YES (e.g., the type of the object is the first attribute), the wearable device 101 according to an embodiment may display, through the display 250, a virtual screen that does not display the movement of the hand object according to the hand tracking.

In an embodiment of the disclosure, the wearable device 101 may identify whether the hand object is located within a first threshold distance (e.g., 1 m) from an object having the first attribute, based on the identification that the type of the object corresponds to the first attribute. For example, the wearable device 101 may display, through the display 250, a virtual screen that does not display the movement of the hand object according to the hand tracking, based on the identification that the hand object is located within the first threshold distance from the object having the first attribute. In another example, the wearable device 101 may display, through the display 250, a virtual screen that displays the movement of the hand object according to the hand tracking, based on the identification that the hand object is located outside the first threshold distance from the object having the first attribute.

In an embodiment of the disclosure, the wearable device 101 may not perform hand tracking in order not to display the movement of the hand object according to the hand tracking. Since the hand tracking is not performed by the wearable device 101, the hand tracking data may not be generated. Since the hand tracking data is not generated, the hand object of the user 110 may not be displayed through the display 250 of the wearable device 101. Since the hand object is not displayed through the display 250 of the wearable device 101, the leakage of the user 110's personal information displayed according to the hand movement of the user 110 may be prevented.

In an embodiment of the disclosure, the wearable device 101 may generate hand tracking data based on the hand tracking. The hand tracking data may include hand location data, hand angle data, hand joint location data, hand joint angle data, hand gesture data, hand shape data, or a combination thereof. However, the disclosure is not limited thereto. For example, the hand tracking data may include only some of the data described above.

In an embodiment of the disclosure, the wearable device 101 may refrain from providing hand tracking data generated according to the hand tracking to an application, a system, and/or an external electronic device, in order not to display the movement of the hand object according to the hand tracking. For example, the wearable device 101 may identify that a display of a hand object located within a threshold distance from the object is restricted based on attribute data of the object. The wearable device 101 may refrain from providing the hand tracking data to the application, the system, and/or the external electronic device, based on the identification that the display of the hand object within the virtual screen is restricted. Since the hand tracking data of the user 110 is not provided to the application, the system, and/or the external electronic device, the hand object may not be displayed through the display 250 of the wearable device 101. Since the hand tracking data is not provided to the application, the system, and/or the external electronic device, the leakage of the user 110's personal information displayed according to the hand movement of the user 110 may be prevented.

In an embodiment of the disclosure, the wearable device 101 may display, through the display 250, a hand object having a default gesture in order not to display the movement of the hand object according to the hand tracking. For example, the wearable device 101 may identify that the display of the hand object located within the threshold distance from the object is restricted, based on the attribute data of the object. The wearable device 101 may display, through the display 250, the hand object having the default gesture, based on the identification that the display of the hand object within the virtual screen is restricted. For example, the wearable device 101 may not use hand angle data, hand joint location data, hand joint angle data, hand gesture data, and hand shape data, for the hand tracking. Since the data is not used for the hand tracking, the hand object displayed through the display 250 of the wearable device 101 may have the default gesture. In an example, the default gesture may correspond to a first gesture. However, this is only an example and the disclosure is not limited thereto. For example, the default gesture may mean an arbitrary gesture having a fixed hand posture (or shape). Since the hand object having the default gesture does not display the hand movement of the user 110, leakage of personal information of the user 110 displayed according to the hand movement of the user 110 may be prevented.

In an embodiment of the disclosure, the wearable device 101 may generate hand tracking data that is different from the hand movement of the user 110, in order not to display the movement of the hand object according to the hand tracking. For example, hand tracking data different from the movement of the user 110's hand may be referred to as dummy data or other terms having equivalent technical meaning. For example, the wearable device 101 may identify that the display of the hand object located within the threshold distance from the object is restricted, based on the attribute data of the object. The wearable device 101 may generate other data different from the hand tracking data according to hand tracking, based on the identification that the display of the hand object is restricted within the virtual screen. For example, the wearable device 101 may generate other data that is different from the hand location data, the hand angle data, the hand joint location data, the hand joint angle data of, the hand gesture data, and the hand shape data, which are generated according to the hand tracking. In an example, since other data different from the hand location data generated according to the hand tracking is generated, a location of the hand object displayed on the display 250 of the wearable device 101 may be different from a location of the hand of the user 110. In an example, since other data different from the hand angle data, the hand joint location data, the hand joint angle data, the hand gesture data, and the hand shape data generated according to the hand tracking are generated, a posture (or shape) of the hand object displayed on the display 250 of the wearable device 101 may be different from a posture (or shape) of the hand of the user 110. Since the location and/or posture of the hand of the user 110 and the location and/or posture of the hand object displayed by the data generated by the wearable device 101 are different, the leakage of personal information of the user 110 displayed according to the hand movement of the user 110 may be prevented.

In operation 1104, in a case of operation 1102—NO (e.g., the type of the object does not correspond to the first attribute), the wearable device 101 according to an embodiment may identify whether the type of the object corresponds to the second attribute. For example, the wearable device 101 may identify whether the type of the object corresponds to the second attribute based on the identification that the type of the object does not correspond to the first attribute.

In operation 1105, in a case of operation 1104—YES (e.g., the type of the object is the second attribute), the wearable device 101 according to an embodiment may refrain from controlling the virtual object using the hand object displayed on the virtual screen. For example, the wearable device 101 may identify whether the hand object is located within a second threshold distance (e.g., 10 cm) from an object having the second attribute, based on the identification that the type of the object corresponds to the second attribute. For example, the wearable device 101 may refrain from controlling the virtual object using the hand object displayed on the virtual screen, based on the identification that the hand object is located within the second threshold distance from the object having the second attribute. In another example, the wearable device 101 may control the virtual object using the hand object displayed on the virtual screen, based on the identification that the hand object is located outside the second threshold distance from the object having the second attribute.

In operation 1106, in a case of operation 1104—NO (e.g., the type of the object does not correspond to the second attribute), the wearable device 101 according to an embodiment may control the virtual object using the hand object displayed on the virtual screen. For example, the wearable device 101 may control the virtual object using the hand object displayed on the virtual screen, based on the identification that the type of the object does not correspond to the second attribute.

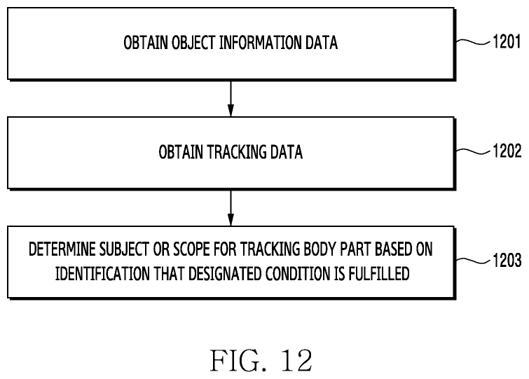

FIG. 12 is a flowchart illustrating an operation of a wearable device for processing a hand object in a virtual screen in accordance with a type of an object in a virtual screen according to an embodiment of the disclosure.

Operations of FIG. 12 may be performed by the electronic device 101 of FIG. 1 or the wearable device 101 of FIGS. 2A, 2B, 3A, 3B, and 4. For example, at least a portion of the operations may be controlled by the processor 410 of the wearable device 101. In the following embodiment of the disclosure, each operation may be performed sequentially, but is not necessarily performed sequentially. For example, the sequence of each operation may be changed. For example, at least two operations may be performed in parallel.

Referring to FIG. 12, in operation 1201, the wearable device 101 according to an embodiment may obtain object information data.

In an embodiment of the disclosure, the wearable device 101 may obtain an image of a surrounding environment by using the camera 260 and/or the sensor 420. The image may include an image of an object outside the wearable device 101 (or a peripheral object, or an external object). The wearable device 101 may perform object recognition based on the image obtained using the camera 260 and/or the sensor 420. For example, the object recognition may be performed based on identifying features (e.g., boundary, corner, edge) of the object included in the image.

In an embodiment of the disclosure, the wearable device 101 may obtain object information data based on object recognition. For example, the object information data may include at least one of location data, type (or category) data, or attribute data of an object identified based on object recognition. For example, the location data of the object may indicate a distance between the object and the user 110, whether an object (or the wearable device 101) is located at a designated location, and/or whether the object exists within a spatially designated tracking range by the user 110. For example, the type (or category) data may indicate a type of the object. The object type may mean a criterion for classifying objects based on a category. In an example, the object type may correspond to one of an automated teller machine (ATM), a door lock, a keyboard, and a mouse. However, this is merely an example, and the disclosure is not limited thereto. For example, the attribute data may indicate one of the attributes associated with an interaction between the object and the hand object of the user 110. The attribute data may correspond to one of the first attribute data, the second attribute data, or the third attribute data. The first attribute data may indicate a first attribute in which a subject or a scope of the tracking is not restricted, or the object information data and the tracking data are processed without restriction by the processor 410. The second attribute data may indicate a second attribute in which the subject or the scope of the tracking is partially restricted, or at least one of the object information data or the tracking data is processed with partial restriction by the processor 410. The third attribute data may indicate a third attribute in which the subject or the scope of the tracking is entirely restricted, or at least one of the object information data or the tracking data is processed with entire restriction by the processor 410.

In operation 1202, the wearable device 101 according to an embodiment may obtain tracking data. For example, the wearable device 101 may obtain tracking data for a body part of the user 110 by performing hand tracking. The tracking data may include location data of the body part of the user 110.

In operation 1203, the wearable device 101 according to an embodiment may determine a subject or a scope for tracking a body part based on identification that a designated condition is fulfilled.

In an embodiment of the disclosure, the designated condition may include at least one of whether an object identified based on object recognition corresponds to a designated object type, a distance between the object and the body part of the user 110, whether the object (or the wearable device 101) is located at a designated location, whether a current time is within a designated time range, whether the object is located within a tracking range spatially designated by the user 110, or whether a current situation corresponds to a situation designated by an artificial intelligence model. For example, the wearable device 101 may identify that a designated condition is fulfilled based on the identification that an object identified based on object recognition corresponds to a designated object type (e.g., ATM). For example, the wearable device 101 may identify that a designated condition is fulfilled based on the identification that a distance between the object and the body part of the user 110 is within a threshold distance. For example, the wearable device 101 may identify that a designated condition is fulfilled, based on the identification that a current time is within a designated time range. For example, the wearable device 101 may identify that a designated condition is fulfilled, based on the identification that the object is located within a tracking range spatially designated by the user 110. For example, the wearable device 101 may identify that a designated condition is fulfilled, based on the identification that a current situation corresponds to a situation designated by an artificial intelligence model.

In an embodiment of the disclosure, the wearable device 101 may determine a subject or a scope of tracking based on an identification that a designated condition is fulfilled. For example, the subject of tracking may be a body part (e.g., hand) of the user 110. For example, the wearable device 101 may refrain from tracking the body part of the user 110, based on the identification that the designated condition is fulfilled. For example, the scope of tracking may be associated with the processing of tracking data obtained through tracking of the body part of the user 110. For example, the wearable device 101 may refrain from transferring tracking data on the body part of the user 110 to an application, based on the identification that the designated condition is fulfilled. In another example, the wearable device 101 may restrict an interaction between the body part of the user 110 and the object, based on an identification that the designated condition is fulfilled. For example, the tracking data on the body part of the user 110 may be processed in a secure area. In an example, the secure area may be a separate area configured within the processor 410, for security. In another example, the secure area may be a separate area (e.g., embedded secure element (eSE), secure processor) configured outside the processor 410 for security. In still another example, the security area may be implemented based on software (e.g., a hypervisor).

In an embodiment of the disclosure, the wearable device 101 may display, through the display 250, the body part of the user 110 within a virtual screen, when the designated condition is fulfilled for an object having a first attribute. The body part of the user 110 displayed within the virtual screen may be capable of interacting with the object.

In an embodiment of the disclosure, the wearable device 101 may display, through the display 250, the body part of the user 110 within the virtual screen, when the designated condition is fulfilled for an object having a second attribute. The body part of the user 110 displayed within the virtual screen may have a restricted interaction with an object.

In an embodiment of the disclosure, the wearable device 101 may not perform hand tracking, in order not to display a movement of the hand object according to the hand tracking, when a designated condition for an object having a third attribute is fulfilled. Since the hand tracking is not performed by the wearable device 101, the hand tracking data may not be generated. Since the hand tracking data is not generated, the hand object of the user 110 may not be displayed through the display 250 of the wearable device 101. Since the hand object is not displayed through the display 250 of the wearable device 101, the leakage of personal information of the user 110 displayed according to the hand movement of the user 110 may be prevented.

In an embodiment of the disclosure, the wearable device 101 may refrain from providing hand tracking data generated according to hand tracking to an application, a system, and/or an external electronic device, in order not to display the movement of the hand object according to the hand tracking, when a designated condition for an object having a third attribute is fulfilled. Since the hand tracking data of the user 110 is not provided to the application, the system, and/or the external electronic device, the hand object may not be displayed through the display 250 of the wearable device 101. Since the hand tracking data is not provided to the application, the system, and/or the external electronic device, the leakage of personal information of the user 110 displayed according to the hand movement of the user 110 may be prevented.

In an embodiment of the disclosure, the wearable device 101 may display, through the display 250, the hand object having a default gesture in order not to display a movement of the hand object according to hand tracking, when a designated condition for an object having a third attribute is fulfilled. For example, the wearable device 101 may not use hand angle data, hand joint location data, hand joint angle data, hand gesture data, and hand shape data, for the hand tracking. Since the data is not used for the hand tracking, the hand object displayed through virtual screen may have the default gesture. In an example, the default gesture may correspond to a first gesture. However, this is only an example and the disclosure is not limited thereto. For example, the default gesture may mean an arbitrary gesture having a fixed hand posture (or shape). Since the hand object having the default gesture does not display the hand movement of the user 110, leakage of personal information of the user 110 displayed according to the hand movement of the user 110 may be prevented.

In an embodiment of the disclosure, the wearable device 101 may generate hand tracking data different from the movement of the user 110's hand, in order not to display the movement of the hand object according to the hand tracking, when a designated condition for an object having a third attribute is fulfilled. For example, the hand tracking data different from the hand movement of the user 110 may be referred to as dummy data or other terms having an equivalent technical meaning. For example, the wearable device 101 may generate other data different from the hand location data, the hand angle data, the hand joint location data, the hand joint angle data, the hand gesture data, and the hand shape data, generated according to the hand tracking. In an example, since other data different from the hand location data generated according to the hand tracking is generated, the location of the hand object displayed through the display 250 of the wearable device 101 may be different from the hand location of the user 110. In an example, since other data different from the hand angle data, the hand joint location data, the hand joint angle data, the hand gesture data, and the hand shape data generated according to hand tracking are generated, a posture (or shape) of the hand object displayed through the display 250 of the wearable device 101 may be different from a posture (or shape) of the hand of the user 110. Since the location and/or posture of the hand of the user 110 and the location and/or posture of the hand object displayed by the data generated by the wearable device 101 are different, leakage of personal information of the user 110 displayed according to the hand movement of the user 110 may be prevented.

A wearable device 101 (or an electronic device) according to the disclosure may prevent leakage of personal information (e.g., password) of the user 110 by restricting a display (or representation) of a hand object displayed on a virtual screen around an object requiring security. The wearable device 101 (or electronic device) according to the disclosure may prevent an unintended action by the user 110 from being performed by refraining from controlling a virtual object using a hand object displayed on a virtual screen around an object that is an input means.

The technical problems to be achieved in this document are not limited to those described above, and other technical problems not mentioned herein will be clearly understood by those having ordinary knowledge in the art to which the disclosure belongs, from the following description.

As described above, a wearable device 101 may comprise at least one camera 260. The wearable device 101 may comprise a display 250. The wearable device 101 may comprise memory 415, including one or more storage media, storing instructions. The wearable device 101 may comprise at least one processor 410 comprising processing circuitry. The instructions, when executed by the at least one processor 410 individually or collectively, may cause the wearable device 101 to identify an object included in a virtual screen displayed through the display 250 using the at least one camera 260. The instructions, when executed by the at least one processor 410 individually or collectively, may cause the wearable device 101 to determine whether the identified object corresponds to a type for restricting a representation of a hand object of a user. The instructions, when executed by the at least one processor 410 individually or collectively, may cause the wearable device 101 to display, through the display 250, a virtual screen including the hand object based on a hand tracking in accordance with a determination that the identified object does not correspond to the type. The instructions, when executed by the at least one processor 410 individually or collectively, may cause the wearable device 101 to display, through the display 250, a virtual screen without displaying a movement of the hand object in accordance with the hand tracking based on identifying that the hand object is located within a threshold distance from the identified object in accordance with a determination that the identified object corresponds to the type.

For example, the instructions, when executed by the at least one processor individually or collectively, may cause the wearable device to identify a location of the hand object based on data different from hand tracking data for a hand of the user generated based on the hand tracking in accordance with the determination that the identified object corresponds to the type. The instructions, when executed by the at least one processor individually or collectively, may cause the wearable device to display the hand object through the display in the identified location.

For example, the instructions, when executed by the at least one processor individually or collectively, may cause the wearable device to display the hand object having a default gesture, through the display, in accordance with the determination that the identified object corresponds to the type.

For example, the instructions, when executed by the at least one processor individually or collectively, may cause the wearable device to refrain from providing hand tracking data in accordance with the hand tracking to an application executed by the wearable device, in accordance with the determination that the identified object corresponds to the type.

For example, the instructions, when executed by the at least one processor individually or collectively, may cause the wearable device to refrain from generating hand tracking data based on the hand tracking in accordance with the determination that the identified object corresponds to the type.

For example, the instructions, when executed by the at least one processor individually or collectively, may cause the wearable device to determine the type for restricting the representation of the hand object and a first type for restricting an interaction of the hand object using an artificial intelligence model.

For example, the instructions, when executed by the at least one processor individually or collectively, may cause the wearable device to determine whether the identified object corresponds to a first type for restricting an interaction of the hand object. The instructions, when executed by the at least one processor individually or collectively, may cause the wearable device to generate hand tracking data indicating a restriction of the interaction by the hand object in accordance with a determination that the identified object corresponds to the first type. The instructions, when executed by the at least one processor individually or collectively, may cause the wearable device to refrain from controlling a virtual object using the hand object displayed in accordance with the hand tracking data, based on identifying that the hand object is located within a first threshold distance from the identified object.

As described above, a method performed by a wearable device 101 comprising a display 250 and at least one camera 260 may comprise identifying an object included in a virtual screen displayed through the display 250 using the at least one camera 260. The method may comprise determining whether the identified object corresponds to a type for restricting a representation of a hand object of a user. The method may comprise displaying, through the display 250, a virtual screen including the hand object based on a hand tracking in accordance with a determination that the identified object does not correspond to the type. The method may comprise displaying, through the display 250, a virtual screen without displaying a movement of the hand object in accordance with the hand tracking based on identifying that the hand object is located within a threshold distance from the identified object in accordance with a determination that the identified object corresponds to the type.

For example, the method may comprise identifying a location of the hand object based on data different from hand tracking data for a hand of the user generated based on the hand tracking in accordance with the determination that the identified object corresponds to the type. The method may comprise displaying the hand object through the display in the identified location.

For example, the method may comprise displaying the hand object having a default gesture, through the display, in accordance with the determination that the identified object corresponds to the type.

For example, the method may comprise refraining from providing hand tracking data in accordance with the hand tracking to an application executed by the wearable device, in accordance with the determination that the identified object corresponds to the type.

For example, the method may comprise refraining from generating hand tracking data based on the hand tracking in accordance with the determination that the identified object corresponds to the type.

For example, the method may comprise determining the type for restricting the representation of the hand object and a first type for restricting an interaction of the hand object using an artificial intelligence model.

For example, the method may comprise determining whether the identified object corresponds to a first type for restricting an interaction of the hand object. The method may comprise generating hand tracking data indicating a restriction of the interaction by the hand object in accordance with a determination that the identified object corresponds to the first type. The method may comprise refraining from controlling a virtual object using the hand object displayed in accordance with the hand tracking data, based on identifying that the hand object is located within a first threshold distance from the identified object.

As described above, a non-transitory computer-readable storage medium may store one or more programs. The one or more programs may comprise instructions which, when executed by at least one processor 410 of a wearable device 101 comprising a display 250 and at least one camera 260, cause the wearable device to identify an object included in a virtual screen displayed through the display 250 using the at least one camera 260. The one or more programs may comprise instructions which, when executed by the at least one processor 410 of the wearable device 101, cause the wearable device to determine whether the identified object corresponds to a type for restricting a representation of a hand object of a user. The one or more programs may comprise instructions which, when executed by the at least one processor 410 of the wearable device 101, cause the wearable device to display, through the display 250, a virtual screen including the hand object based on a hand tracking in accordance with a determination that the identified object does not correspond to the type. The one or more programs may comprise instructions which, when executed by the at least one processor 410 of the wearable device 101, cause the wearable device to display, through the display 250, a virtual screen without displaying a movement of the hand object in accordance with the hand tracking based on identifying that the hand object is located within a threshold distance from the identified object in accordance with a determination that the identified object corresponds to the type.

For example, the one or more programs may comprise instructions which, when executed by the at least one processor of the wearable device, cause the wearable device to identify a location of the hand object based on data different from hand tracking data for a hand of the user generated based on the hand tracking in accordance with the determination that the identified object corresponds to the type. The one or more programs may comprise instructions which, when executed by the at least one processor of the wearable device, cause the wearable device to display the hand object through the display in the identified location.

For example, the one or more programs may comprise instructions which, when executed by the at least one processor of the wearable device, cause the wearable device to display the hand object having a default gesture, through the display, in accordance with the determination that the identified object corresponds to the type.

For example, the one or more programs may comprise instructions which, when executed by the at least one processor of the wearable device, cause the wearable device to refrain from providing hand tracking data in accordance with the hand tracking to an application executed by the wearable device, in accordance with the determination that the identified object corresponds to the type.

For example, the one or more programs may comprise instructions which, when executed by the at least one processor of the wearable device, cause the wearable device to refrain from generating hand tracking data based on the hand tracking in accordance with the determination that the identified object corresponds to the type.

For example, the one or more programs may comprise instructions which, when executed by the at least one processor of the wearable device, cause the wearable device to determine the type for restricting the representation of the hand object and a first type for restricting an interaction of the hand object using an artificial intelligence model.

For example, the one or more programs may comprise instructions which, when executed by the at least one processor of the wearable device, cause the wearable device to determine whether the identified object corresponds to a first type for restricting an interaction of the hand object. The one or more programs may comprise instructions which, when executed by the at least one processor of the wearable device, cause the wearable device to generate hand tracking data indicating a restriction of the interaction by the hand object in accordance with a determination that the identified object corresponds to the first type. The one or more programs may comprise instructions which, when executed by the at least one processor of the wearable device, cause the wearable device to refrain from controlling a virtual object using the hand object displayed in accordance with the hand tracking data, based on identifying that the hand object is located within a first threshold distance from the identified object.

As described above, a wearable device may comprise at least one display. The wearable device may comprise at least one sensor. The wearable device may comprise at least one processor including processing circuitry. The wearable device may comprise memory, including one or more storage media, storing instructions. The instructions, when executed by the at least one processor individually or collectively, may cause the wearable device to obtain object information data on an object identified by the at least one sensor. The instructions, when executed by the at least one processor individually or collectively, may cause the wearable device to obtain tracking data by tracking a body part identified by the at least one sensor. The instructions, when executed by the at least one processor individually or collectively, may cause the wearable device to identify whether a designated condition is fulfilled. The instructions, when executed by the at least one processor individually or collectively, may cause the wearable device to, based on the identification, determine a subject or a scope of a tracking, or determine a subject or a scope of the tracking data processed by the at least one processor.

For example, the object information data may include at least one of location data, type data, or attribute data for each object identified by the at least one sensor. The designated condition may include at least one of whether the object corresponds to a designated type, a distance between the object and the body part, whether the object or the wearable device is located in a designated location, whether a current time is within a designated time range, whether the object exists within a tracking range spatially designated by the body part, or whether a current situation corresponds to a situation designated by an artificial intelligence model.

For example, the attribute data may include at least two of first attribute data related to a first attribute that a subject or a scope of the tracking is not restricted or that the object information data and the tracking data is processed without restrictions by the at least one processor, second attribute data related to a second attribute that the subject or the scope of the tracking is partially restricted or that at least one of the object information data or the tracking data is processed with partial restriction by the at least one processor, in a case the at least one condition of the designated condition is fulfilled, or third attribute data related to a third attribute that the subject or the scope of the tracking is entirely restricted or that at least one of the object information data or the tracking data is processed with entire restriction by the at least one processor, in a case that the at least one condition of the designated condition is fulfilled.

For example, the at least one processor may comprise a virtual space manager configured to receive sensor data from the at least one sensor, and generate a visual image for supporting a virtual space service based on the sensor data. At least one application stored in the memory may cause the at least one display to display a screen displaying at least part of a virtual space or a screen displaying two-dimensional image, based on at least one of the sensor data, the object information data, or the tracking data.

For example, the one or more programs may comprise instructions which, when executed by the at least one processor of the wearable device, cause the wearable device to cause the virtual space manager to refrain from processing the received sensor data or to process the sensor data with restrictions, based on the determined subject or the determined scope of the tracking data.

For example, the one or more programs may comprise instructions which, when executed by the at least one processor of the wearable device, cause the wearable device to cause the virtual space manager to refrain from transferring at least part of the sensor data, the object information data, or the tracking data to the at least one application, based on the determined subject or the determined scope of the tracking data.

The effects that can be obtained from the disclosure are not limited to those described above, and any other effects not mentioned herein will be clearly understood by those having ordinary knowledge in the art to which the disclosure belongs, from the following description.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in random access memory, non-volatile memory including flash memory, read only memory (ROM), electrically erasable programmable read only memory (EEPROM), magnetic disc storage device, compact disc-ROM (CD-ROM), optical storage device (digital versatile discs (DVDs) or other formats), or magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments of the disclosure, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments of the disclosure, operations performed by the module, the program, or another component may be executed sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the scope of the disclosure as defined by the appended claims and their equivalents.

What is claimed is:

1. A wearable device comprising:
at least one camera;
a display;
memory, comprising one or more storage media, storing instructions; and
at least one processor comprising processing circuitry and communicatively coupled to the at least one camera, the display, and the memory,
wherein the instructions, when executed by the at least one processor individually or collectively, cause the wearable device to:
identify an object included in a virtual screen displayed through the display using the at least one camera,
determine whether the identified object corresponds to a type for restricting a representation of a hand object of a user,
display, through the display, a virtual screen including the hand object based on a hand tracking in accordance with a determination that the identified object does not correspond to the type, and
display, through the display, a virtual screen without displaying a movement of the hand object in accordance with the hand tracking based on identifying that the hand object is located within a threshold distance from the identified object in accordance with a determination that the identified object corresponds to the type.

2. The wearable device of claim 1, wherein the instructions, when executed by the at least one processor individually or collectively, further cause the wearable device to:
identify a location of the hand object based on data different from hand tracking data for a hand of the user generated based on the hand tracking in accordance with the determination that the identified object corresponds to the type, and
display the hand object through the display in the identified location.

3. The wearable device of claim 1, wherein the instructions, when executed by the at least one processor individually or collectively, further cause the wearable device to:
display the hand object having a default gesture, through the display, in accordance with the determination that the identified object corresponds to the type.

4. The wearable device of claim 1, wherein the instructions, when executed by the at least one processor individually or collectively, further cause the wearable device to:
refrain from providing hand tracking data in accordance with the hand tracking to an application executed by the wearable device, in accordance with the determination that the identified object corresponds to the type.

5. The wearable device of claim 1, wherein the instructions, when executed by the at least one processor individually or collectively, further cause the wearable device to:
refrain from generating hand tracking data based on the hand tracking in accordance with the determination that the identified object corresponds to the type.

6. The wearable device of claim 1, wherein the instructions, when executed by the at least one processor individually or collectively, further cause the wearable device to:
determine the type for restricting the representation of the hand object and a first type for restricting an interaction of the hand object using an artificial intelligence model.

7. The wearable device of claim 1, wherein the instructions, when executed by the at least one processor individually or collectively, further cause the wearable device to:
determine whether the identified object corresponds to a first type for restricting an interaction of the hand object;
generate hand tracking data indicating a restriction of the interaction by the hand object in accordance with a determination that the identified object corresponds to the first type; and
refrain from controlling a virtual object using the hand object displayed in accordance with the hand tracking data, based on identifying that the hand object is located within a first threshold distance from the identified object.

8. A method performed by a wearable device comprising a display and at least one camera, the method comprising:
identifying an object included in a virtual screen displayed through the display using the at least one camera;
determining whether the identified object corresponds to a type for restricting a representation of a hand object of a user;
displaying, through the display, a virtual screen including the hand object based on a hand tracking in accordance with a determination that the identified object does not correspond to the type; and
displaying, through the display, a virtual screen without displaying a movement of the hand object in accordance with the hand tracking based on identifying that the hand object is located within a threshold distance from the identified object in accordance with a determination that the identified object corresponds to the type.

9. The method of claim 8, further comprising:
identifying a location of the hand object based on data different from hand tracking data for a hand of the user generated based on the hand tracking in accordance with the determination that the identified object corresponds to the type; and
displaying the hand object through the display in the identified location.

10. The method of claim 8, further comprising:
displaying the hand object having a default gesture, through the display, in accordance with the determination that the identified object corresponds to the type.

11. The method of claim 8, further comprising:
refraining from providing hand tracking data in accordance with the hand tracking to an application executed by the wearable device, in accordance with the determination that the identified object corresponds to the type.

12. The method of claim 8, further comprising:
refraining from generating hand tracking data based on the hand tracking in accordance with the determination that the identified object corresponds to the type.

13. The method of claim 8, further comprising:
determining the type for restricting the representation of the hand object and a first type for restricting an interaction of the hand object using an artificial intelligence model.

14. The method of claim 8, further comprising:
determining whether the identified object corresponds to a first type for restricting an interaction of the hand object;
generating hand tracking data indicating a restriction of the interaction by the hand object in accordance with a determination that the identified object corresponds to the first type; and
refraining from controlling a virtual object using the hand object displayed in accordance with the hand tracking data, based on identifying that the hand object is located within a first threshold distance from the identified object.

15. A non-transitory computer-readable storage medium storing one or more programs including instructions that, when executed by at least one processor of a wearable device comprising a display and at least one camera individually or collectively, cause the wearable device to:
identifying an object included in a virtual screen displayed through the display using the at least one camera;
determining whether the identified object corresponds to a type for restricting a representation of a hand object of a user;
displaying, through the display, a virtual screen including the hand object based on a hand tracking in accordance with a determination that the identified object does not correspond to the type; and
displaying, through the display, a virtual screen without displaying a movement of the hand object in accordance with the hand tracking based on identifying that the hand object is located within a threshold distance from the identified object in accordance with a determination that the identified object corresponds to the type.

16. The non-transitory computer-readable storage medium of claim 15, wherein the one or more programs further includes instructions that, when executed by the at least one processor individually or collectively, cause the wearable device to:
identify a location of the hand object based on data different from hand tracking data for a hand of the user generated based on the hand tracking in accordance with the determination that the identified object corresponds to the type, and
display the hand object through the display in the identified location.

17. The non-transitory computer-readable storage medium of claim 15, wherein the one or more programs further includes instructions that, when executed by the at least one processor individually or collectively, cause the wearable device to:
display the hand object having a default gesture, through the display, in accordance with the determination that the identified object corresponds to the type.

18. The non-transitory computer-readable storage medium of claim 15, wherein the one or more programs further includes instructions that, when executed by the at least one processor individually or collectively, cause the wearable device to:
refrain from providing hand tracking data in accordance with the hand tracking to an application executed by the wearable device, in accordance with the determination that the identified object corresponds to the type.

19. The non-transitory computer-readable storage medium of claim 15, wherein the one or more programs further includes instructions that, when executed by the at least one processor individually or collectively, cause the wearable device to:
refrain from generating hand tracking data based on the hand tracking in accordance with the determination that the identified object corresponds to the type.

20. The non-transitory computer-readable storage medium of claim 15, wherein the one or more programs further includes instructions that, when executed by the at least one processor individually or collectively, cause the wearable device to:
determine the type for restricting the representation of the hand object and a first type for restricting an interaction of the hand object using an artificial intelligence model.
